(19) United States
(12) Patent Application Publication
(10) Pub. No.: US 2025/0163696 A1
(43) Pub. Date: May 22, 2025

(54) WALL PANEL SYSTEM

(71) Applicant: Steelcase Inc., Grand Rapids, MI (US)

(72) Inventors: Jacob H. Bruner, Lowell, MI (US); Brook R. Burg, Grand Rapids, MI (US); Justin Michael Clark, Hudsonville, MI (US); Bruce W. Duvall, JR., Grand Rapids, MI (US); Thomas G. Feldpausch, Hastings, MI (US); Ryan Geister, Alto, MI (US); Theodore M. Haan, Byron Center, MI (US); Allen Hager, Grand Rapids, MI (US); David Michael Kerley, Allegan, MI (US); Paul Mitchell Pierce, Allendale, MI (US); Mark T. Slager, Caledonia, MI (US); Kevin Andrew Still, Wyoming, MI (US); Piet Visser, Grand Rapids, MI (US)

(21) Appl. No.: 19/027,812

(22) Filed: Jan. 17, 2025

Related U.S. Application Data
(63) Continuation of application No. PCT/IB2023/058384, filed on Aug. 23, 2023.
(60) Provisional application No. 63/400,466, filed on Aug. 24, 2022.

(51) Int. Cl. E04B 2/74

(52) U.S. Cl. CPC E04B 2/74; E04B 2002/7461

(57) ABSTRACT

A wall panel system includes a plurality of floor to ceiling wall panels. The wall panels include connecting structures along opposite edges that may utilize common connectors whereby various types of panels can be installed adjacent to one another in virtually any desired arrangement. Because common connectors can be utilized, existing wall panels can be removed and replaced with different wall panels to thereby reconfigure the wall panel system. The wall panels may include solid panels, glass panels, clerestory panels, pivoting door panels, sliding door panels, or other panels as required for a particular application.

### CROSS-REFERENCE TO RELATED APPLICATIONS

This application is a continuation of PCT Patent Application Serial No. PCT/IB2023/058384, filed on Aug. 23, 2023, entitled, “WALL PANEL SYSTEM,” which application claims the benefit under 35 U.S.C. § 119 (e) to U.S. Provisional Patent Application No. 63/400,466, filed Aug. 24, 2022, entitled “WALL PANEL SYSTEM,” the contents of each is incorporated herein by reference in their entirety.

### BACKGROUND

The efficient use of building floor space is a concern. Open office plans have been developed to reduce overall officing costs, and generally incorporate large, open floor spaces in buildings that are equipped with modular furniture systems which are readily reconfigurable to accommodate the ever-changing needs of a specific user, as well as the divergent requirements of different tenants. One arrangement commonly used for furnishing open plans includes movable or portable partition panels that are detachably interconnected to partition off the open spaces into individual workstations and/or offices. Such partition panels are configured to receive hang-on furniture units, such as worksurfaces, overhead cabinets, shelves, etc., and are generally known in the office furniture industry as “systems furniture.”

### BRIEF SUMMARY OF THE INVENTION

An aspect of the present disclosure is a partition wall including a ceiling track, a floor track, and a pair of upright partition frame members extending between the ceiling track and the floor track. The floor track may have a length that is approximately equal to the partition assembly, and the floor track may be operably connected to a frame of the partition assembly. The partition wall assembly further includes a lower partition frame member having opposite ends thereof secured to the upright partition frame members, and an adjustable glide having a lower end that extends through the floor track to directly engage a floor surface to support the lower partition frame member. The adjustable glide may operably connect the floor track to the lower partition frame member. The partition wall further includes a clerestory assembly including a sheet of light-transmitting material and a clerestory frame. The clerestory frame includes a plurality of clerestory frame members including an upper clerestory frame member, a lower clerestory frame member, and a pair of upright clerestory frame members secured to the upright partition frame members. Each clerestory frame member includes first and second elongated tubular outer portions and a central structure between the first and second elongated tubular outer portions. The central structure includes a central channel. The elongated tubular outer portions may be integrally formed with the central structure. The sheet of light-transmitting material includes outer edges, portions of which are positioned in the channels to retain the sheet of light-transmitting material in the clerestory frame. The first and second tubular outer portions of each clerestory frame member define exposed outer surfaces on first and second sides of the clerestory assembly, respectively, wherein the first and second sides are opposite one another. The exposed outer surfaces of each clerestory frame member on at least the first side of the clerestory assembly are coplanar. The upper and lower clerestory frame members are rigidly interconnected to the upright clerestory frame members. The upper and lower clerestory frame members may include screw bosses at opposite ends thereof that receive fasteners extending through the upright clerestory frame members. The clerestory assembly further includes a panel attachment structure below each of the first and second tubular outer portions of the lower clerestory frame member, and an opaque panel attached to the panel attachment structure of the lower clerestory frame member, the upright partition frame members, and the lower partition frame member. An outer surface of the opaque panel is substantially coplanar with the exposed outer surface of the tubular outer portion of the lower clerestory frame member.

Another aspect of the present disclosure is a glass kit or partition for partition walls that is configured to be assembled on site to form an assembled glass partition assembly having first and second opposite sides. The glass kit or partition includes one or more sheets of glass, upper and lower frame members, and upright side frame members that are configured to be secured to the upper and lower frame members. The glass kit or partition further includes side trim members whereby vertical side edges of the one or more sheets of glass can be positioned between the upright side frame members and the side trim members. The side trim members have outer profiles that are substantially identical to outer profiles of the upright side frame members whereby the first and second opposite sides of the assembled glass partition assembly have a substantially identical appearance. The glass kit or partition further includes spacers that are configured to be positioned at opposite ends of the upper frame member to extend a profile of the upper frame member to the upright side frame members. The upright side frame members, spacers, and upper and lower frame members are configured to be assembled to form a frame, such that following assembly of the frame an upper edge of the one or more sheets of glass may be inserted into a grove of the upper frame member, and the one or more sheets of glass may then be rotated to a vertical position, and the glass may be shifted downwardly to insert a lower edge of the one or more sheets of glass into a groove of the lower frame member, followed by installing the side trim members to the upright side frame members utilizing clips positioned on the upright side frame members.

Another aspect of the present disclosure is a solid panel including a rigid frame having upper and lower frame members and upright frame members that are interconnected to the upper and lower frame members. Each of the upper and lower frame members and the upright frame members have channels facing a central space of the rigid frame. The partition further includes a panel that is attached to the rigid frame in an installed position by a plurality of latches and a plurality of brackets. Each bracket includes a portion that extends downwardly from a lower edge of the panel and engages the channel of the lower frame member whereby the skin is pivotable about the plurality of brackets during installation of the panel on the rigid frame. Each latch includes a movable retainer that is spring-biased towards a latched position. Each movable retainer has an angled surface that is configured to engage the frame members and cause the movable retainer to move away from the latched position as the panel is pivoted about the plurality of brackets to the installed position on the rigid frame. The movable retainers are configured to shift to the latched position due to the spring bias when the panel is pivoted into the installed position. The movable retainers further include retaining surfaces that engage the channels when the movable retainers are in the latched position to thereby retain the panel in the installed position on the rigid frame.

Another aspect of the present disclosure is a sliding door assembly for partition walls. The sliding door assembly includes upright frame rails and a stationary door frame having a header that is connected to the upright frame rails, and first and second upwardly opening channels extending along an upper edge of the stationary door frame. The sliding door assembly further includes a ceiling channel having downwardly extending side flanges that are received in the upwardly opening channels of the stationary door frame. The sliding door assembly further includes a door track having a roller-receiving channel and a downwardly opening hook. An end of the downwardly opening hook is received in the first upwardly opening support channel to support the door track on the stationary door frame. The sliding door assembly further includes a door having a sheet of material and rollers attached to an upper edge of the sheet of material. The sheet of material may comprise light-transmitting material. The rollers are disposed in the roller-receiving channel to slidably support the door for horizontal movement along the door track.

Another aspect of the present disclosure is a method of installing a door frame and a swinging door in a wall system. The method includes measuring a vertical dimension of a door opening in a wall system, and cutting side frame members to a length that will permit the side frame members to be positioned in the door opening in an upright position. The method further includes connecting the side frame members to an overhead frame member to form a door frame. The method further includes temporarily attaching floor brackets to lower ends of the side frame members, and the door frame is temporarily positioned in an installed position in which the door frame engages a ceiling track of the wall system and the floor brackets rest on a floor surface. The locations of the floor brackets on the floor surface are then marked, and the door frame is then removed from the installed position. This is followed by removing the floor brackets from the side frame members, and the floor brackets are then positioned on the floor using the marked locations on the floor. The floor brackets are then secured to the floor, and the lower ends of the side frame members are then attached to the floor brackets. The door frame is positioned in the door opening with the side frame members in upright positions.

These and other features, advantages, and objects of the present invention will be further understood and appreciated by those skilled in the art by reference to the following specification, claims, and appended drawings.

### BRIEF DESCRIPTION OF THE DRAWINGS

FIG. 1 is an isometric view of a wall panel system according to an aspect of the present disclosure;

FIG. 2 is a cross-sectional view of a solid wall panel of FIG. 1 taken along the line 2-2; FIG. 1;

FIG. 3 is a side plan view of a partition frame for solid wall panels;

FIG. 4 is a side elevational view of the partition frame of FIG. 3;

FIG. 5 is a front elevational view of a frame member of the frame of FIG. 3;

FIG. 6 is a side elevational view of the frame member of FIG. 5;

FIG. 7 is a front elevational view of a frame member of the frame of FIG. 3;

FIG. 8 is a side elevational view of the frame member of FIG. 7;

FIG. 9 is a cross-sectional view of the frame of FIG. 4 taken along the line 9-9; FIG. 4;

FIG. 10 is a cross-sectional view of the frame of FIG. 9 taken along the line 10-10; FIG. 9;

FIG. 11 is a partially fragmentary enlarged view of a portion of the frame of FIG. 4;

FIG. 12 is partially fragmentary cross-sectional view taken along the line 12-12; FIG. 1;

FIG. 13 is a partially fragmentary isometric view showing installation of a wall panel of a wall panel system according to an aspect of the present disclosure;

FIG. 14 is a cross-sectional view taken along the line 14-14; FIG. 1;

FIG. 15 is a partially fragmentary perspective view of a portion of a solid wall panel according to an aspect of the present disclosure;

FIG. 16 is a partially fragmentary view of a glass wall panel taken along the line 16-16; FIG. 1;

FIG. 17 is a cross-sectional view of a glass wall panel taken along the line 17-17; FIG. 1;

FIG. 18 is a side elevational view of the glass wall panel of FIG. 17;

FIG. 19 is a partially fragmentary enlarged view of a portion of the glass wall panel of FIG. 17;

FIG. 20 is a partially fragmentary isometric view of an end of a muntin of the glass wall panel of FIGS. 17-19;

FIG. 21 is a cross-sectional view taken along the line 21-21; FIG. 18;

FIG. 22 is a partially fragmentary cross-sectional view taken along the line 22-22; FIG. 1;

FIG. 23 is an isometric view of a glass wall panel assembled from the kit of FIG. 24;

FIG. 24 is an exploded isometric view of the glass wall panel of FIG. 23;

FIG. 25 is a partially fragmentary isometric view showing a top portion of a glass wall panel of FIG. 23;

FIG. 26 is a partially fragmentary isomeric view showing a bottom portion of the glass wall panel of FIG. 23;

FIG. 27 is a partially fragmentary isometric view showing a top portion of a partially assembled glass wall panel;

FIG. 28 is a partially fragmentary isometric view of upper and lower frame members of the glass wall panel of FIG. 23, wherein the spacers are connected to ends of the frame members;

FIG. 29 is a partially fragmentary cross-sectional view of a portion of a partially assembled glass wall panel;

FIG. 30 is a partially fragmentary cross-sectional view of a portion of a glass wall panel taken along the line 30-30; FIG. 23;

FIG. 31 is a partially fragmentary cross-sectional view of a clerestory wall panel taken along the line 31-31; FIG. 1;

FIG. 32 is a partially fragmentary isometric view of a portion of the clerestory wall panel of FIG. 31;

FIG. 33 is a partially fragmentary isometric view of an upper portion of an upright frame member of the clerestory wall panel of FIG. 31;

FIG. 34 is a partially fragmentary isometric view of a lower end portion of an upright frame member of the clerestory wall panel of FIG. 31;

FIG. 35 is a partially fragmentary isometric view of an end portion of an upper clerestory frame member;

FIG. 36 is a partially fragmentary isometric view of an end portion of a lower clerestory frame member;

FIG. 37 is a partially fragmentary isometric view of an upper corner portion of the clerestory wall panel of FIG. 32;

FIG. 38 is a partially fragmentary isometric view of a lower corner portion of the clerestory wall panel of FIG. 31;

FIG. 39 is a cross-sectional view of the clerestory wall panel of FIG. 32 corresponding to FIG. 40 prior to securing the clerestory frame member to the partition frame member;

FIG. 40 is a partially fragmentary cross-sectional view of the clerestory wall panel of FIG. 32 taken along the line 40-40;

FIG. 41 is a partially fragmentary cross-sectional view showing an alternative solid panel attachment;

FIG. 42 is a partially fragmentary cross-sectional view showing an alternative solid panel attachment;

FIG. 43 is a partially fragmentary view of a corner post according to another aspect of the present disclosure;

FIG. 44 is a partially fragmentary isometric view of a lower portion of a glass wall panel and glide according to another aspect of the present disclosure;

FIG. 45 is a partially fragmentary end view of a lower portion of the glass wall panel and glide of FIG. 44;

FIG. 46 is a partially fragmentary cross-sectional view taken along the line 46-46; FIG. 46;

FIG. 47 is a partially fragmentary isometric view of a glide that may be utilized in the glass wall panel of FIGS. 44-46;

FIG. 48 is a front elevational view of a portion of the glide of FIG. 47;

FIG. 49 is a cross-sectional view of a portion of the glide of FIG. 48 taken along the line 49-49;

FIG. 50 is a partially fragmentary enlarged view of a lower portion of the glide of FIG. 49 in an installed configuration;

FIG. 51 is a partially fragmentary enlarged view of a lower portion of the glide of FIG. 52 further including a floor seal;

FIG. 52 is a partially fragmentary isometric view of a lower portion of the glass wall panel of FIGS. 44-46;

FIG. 53 is an isometric view of a wrench that may be utilized to adjust the glide of FIGS. 44-52;

FIG. 54 is an exploded isometric view of a glide according to another aspect of the present disclosure;

FIG. 55 is an isometric view of the glide of FIG. 54 in an assembled condition;

FIG. 56 is a partially fragmentary cross-sectional view showing a wall panel including the glide of FIGS. 54-55;

FIG. 57 is a partially fragmentary cross-sectional view showing a wall panel including the glide of FIGS. 54-55;

FIG. 58 is a partially fragmentary isometric view of a solid wall panel including a panel that is secured to a partition frame by one or more brackets and latches;

FIG. 59 is an exploded isometric view of a latch;

FIG. 60 is a partially fragmentary perspective view of the latch of FIG. 59 showing the latch engaging a post of a partition frame;

FIG. 61 is a partially fragmentary perspective view of the latch of FIG. 59 showing the latch engaging a post of a partition frame;

FIG. 62 is a partially fragmentary perspective view of a bracket;

FIG. 63 is an isometric view showing installation of a panel onto a partition frame;

FIG. 64 is a partially fragmentary view of a lower portion of a panel during installation to a partition frame;

FIG. 65 is an isometric view showing a stationary door frame for a sliding door and an adjacent wall panel;

FIG. 66 is a partially fragmentary view of an upper portion of the sliding door assembly of FIG. 65;

FIG. 67 is a partially fragmentary isometric view of a left-hand frame rail of a sliding door;

FIG. 68 is a partially fragmentary isometric view of a right-hand frame rail of a sliding door;

FIG. 69 is a partially fragmentary exploded isometric view showing an upper portion of a stationary door frame of the sliding door of FIG. 66;

FIG. 70 is an enlarged view of a portion of the stationary door frame of FIG. 69;

FIG. 71 is a partially fragmentary isometric view corresponding to FIG. 70 showing the stationary door frame components in an assembled condition;

FIG. 72 is a partially fragmentary top plan view of the stationary door frame of FIG. 69 when assembled;

FIG. 73 is a partially fragmentary view of the stationary door frame of FIGS. 69-72 showing the stationary door frame in an installed position engaging a ceiling track;

FIG. 73A is a partially fragmentary view of a floor bracket of FIG. 73 wherein the floor bracket includes an optional door guide structure;

FIG. 73B is a partially fragmentary view of a floor bracket of FIG. 73 wherein the floor bracket includes an optional door guide structure;

FIG. 74 is a partially fragmentary isometric view showing the stationary door frame engaging the ceiling track during assembly;

FIG. 75 is a partially fragmentary cross sectional view showing installation of an overhead door track of the sliding door to the stationary door frame;

FIG. 76 is a partially fragmentary isometric view showing the door track of the sliding door when assembled;

FIG. 77 is a partially fragmentary enlarged isometric view showing a portion of the door track when assembled;

FIG. 78 is a partially fragmentary enlarged isometric view showing a portion of the door track when assembled;

FIG. 79 is a partially fragmentary exploded isometric view showing assembly of an acoustic seal in the sliding door assembly;

FIG. 80 is an enlarged partially fragmentary enlarged view of a portion of FIG. 79;

FIG. 81 is a partially fragmentary cross-sectional view showing the acoustic seal of FIG. 79-80;

FIG. 82 is an isometric view showing a bracket secured to a sheet of material of the sliding door;

FIG. 83 is a partially fragmentary view showing a sliding door in an installed position;

FIG. 84 is a partially fragmentary exploded isometric view showing assembly of a channel assembly adjacent to a lower edge of the door;

FIG. 85 is an end view showing the channel assembly secured to a lower portion of the door;

FIG. 86 is a partially fragmentary exploded isometric view showing covers that are secured to the channel assembly of FIG. 85;

FIG. 87 is a partially fragmentary view showing installation of a door handle;

FIG. 88 is a front elevational view of a swing door assembly that may be utilized in the partition of FIG. 1;

FIG. 89 is an isometric view showing floor brackets that may be utilized to secure a stationary frame of the swing door of FIG. 88 to a floor;

FIG. 90 is a partially fragmentary isometric view showing a floor bracket temporarily secured to a lower end of upright door frame member;

FIG. 91 is a partially fragmentary isometric view showing positioning and marking of floor brackets on a floor surface;

FIG. 92 is an isometric view showing a floor bracket positioned on a floor surface utilizing tape or other markers to position the floor bracket;

FIG. 93 is a partially fragmentary isometric view showing an upright frame member positioned on the floor bracket of FIG. 92;

FIG. 94 is a top plan view showing an alternative method of installing the floor brackets of FIG. 89;

FIG. 95 is a partially fragmentary exploded isometric view corresponding to FIG. 97A;

FIG. 96 is a top plan view of the swing door of FIG. 88;

FIG. 97 is a side elevational view of a vertical door frame member;

FIG. 98 is a partially fragmentary view of an upper end of the door frame member of FIG. 97;

FIG. 99 is a partially fragmentary isometric view showing an upright frame member and hinge truck;

FIG. 100 is a partially fragmentary isometric view showing an upright frame member and striker truck;

FIG. 101 is an end view of an upright door frame member;

FIG. 102 is a partially fragmentary view of a lower end of an upright door frame member;

FIG. 103 is a partially fragmentary view of a portion of an upright door frame member showing mounting of two hinge trucks;

FIG. 104 is a partially fragmentary view of an upper portion of an upright door frame member showing mounting of an upper hinge truck;

FIG. 105 is a partially fragmentary view of a lower portion of an upright door frame member showing mounting of a striker truck;

FIG. 106 is a partially fragmentary view of an upper portion of the upright door frame member of FIG. 109 showing an upper cover member;

FIG. 107 is a partially fragmentary exploded isometric view showing an upper portion of a door frame member;

FIG. 108 is a partially exploded isometric view showing assembly of a pair of door frame uprights and an overhead door frame member;

FIG. 109 is a partially fragmentary exploded isometric view showing interconnection of an upright door frame member and an overhead door frame member; and

FIG. 110 is a partially fragmentary exploded isometric view showing mounting of a striker plate to a striker truck.

### DETAILED DESCRIPTION

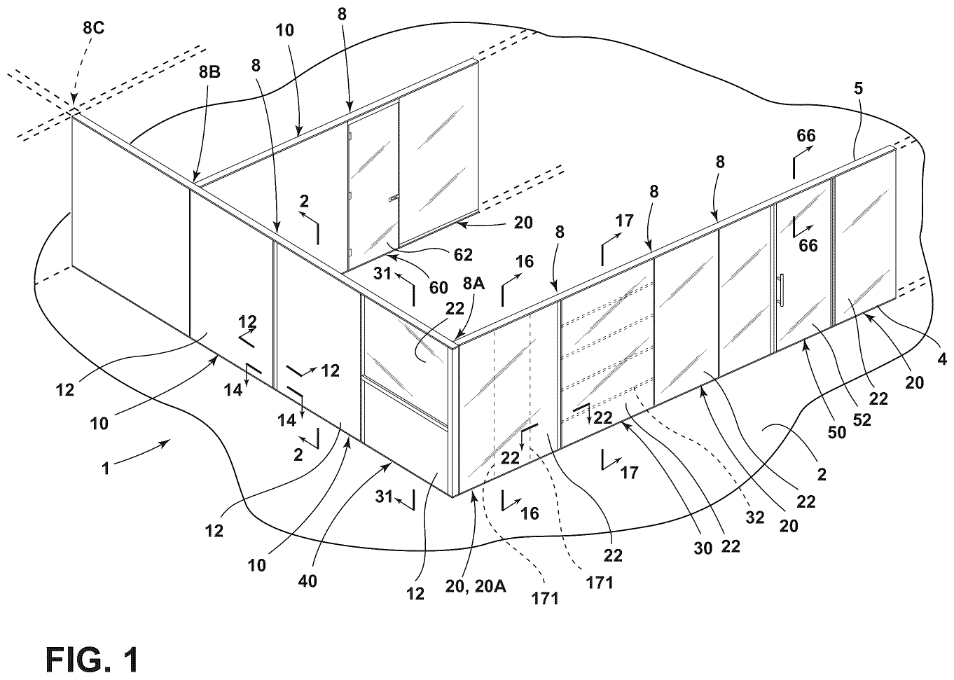

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

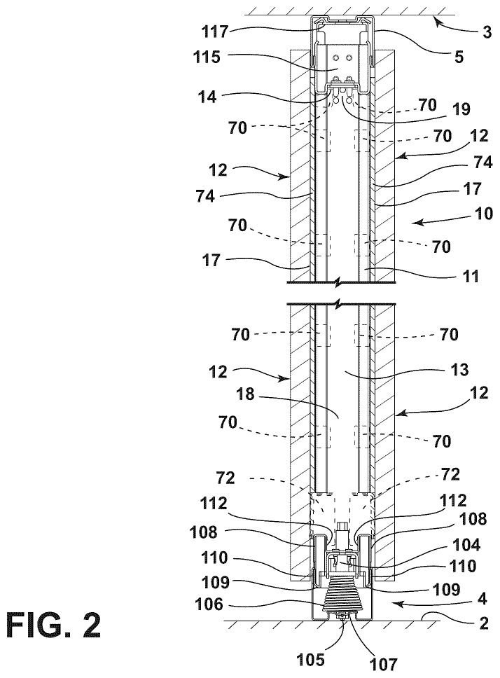

With reference to FIGS. 1 and 2, a wall panel system 1 according to the present disclosure may comprise a floor-to-ceiling system that may extend between a floor 2 and a ceiling 3 of an existing building or other structure. As discussed in more detail below, each wall panel of the wall panel system 1 may include a floor track 4 segment that is positioned on a floor surface 2 when the panel is installed. Typically, floor track 4 abuts floor 2 without being secured to the floor 2. However, floor track 4 could be secured to floor 2 using threaded fasteners or the like if required for a particular application. An elongated ceiling track 5 may be secured to a ceiling 3 prior to installation of the individual wall panels.

Wall panel system 1 may include one or more solid wall panels 10. Each solid wall panel 10 may include one or more outer skins or panels 12 that may be opaque and/or absorb sound. The panels 12 may also be referred to herein as skins or tiles. The system may also include one or more glass wall panels 20 having a sheet of material 22 that may be light-transmitting or transparent. The sheet of material 22 may comprise glass, polymer, or other suitable material. It will be understood that the term “glass wall panel” is not limited to wall panels in which the sheet of material 22 comprises glass. The system may further include one or more glass wall panels 30 that include a sheet of material 22, and further include one or more horizontal members such as muntins 32.

A wall panel system 1 according to an aspect of the present disclosure may further include a clerestory wall panel 40 having an upper portion that includes a light-transmitting sheet of material 22, and a lower portion having a solid panel or skin 12.

Wall panel system 1 may also include a sliding door assembly 50 including a sheet of material 52. The sheet 52 may be solid (e.g. wood, metal, etc.), or the sheet 52 may comprise glass or other light-transmitting material. Wall panel system 1 may further include a pivoting door assembly 60 having a sheet of glass or other light-transmitting material 62.

Wall panels 10, 20, 30, 40 and door assemblies 50, 60 may be interconnected at inline joints 8, corner joints 8A, or T joints 8B. As discussed below, each of the walls panels 10, 20, 30, 40 and door assemblies 50, 60 include substantially similar connecting structures that can be utilized at a joint 8, 8A or 8B whereby any panel or door 10, 20, 30, 40, 50, 60, etc. can be readily connected to any other panel or door 10, 20, 30, 50, 60, etc. Thus, wall panels 10, 20, 30, and 40 are generally interchangeable with one another or with door assemblies 50, 60. This simplifies the initial assembly of wall panel system 1, and also permits a wall panel to be reconfigured by replacing existing wall panels or doors with panels of a different type. For example, solid wall panels 10 can be replaced with glass wall panels 20 or 30, or visa-versa.

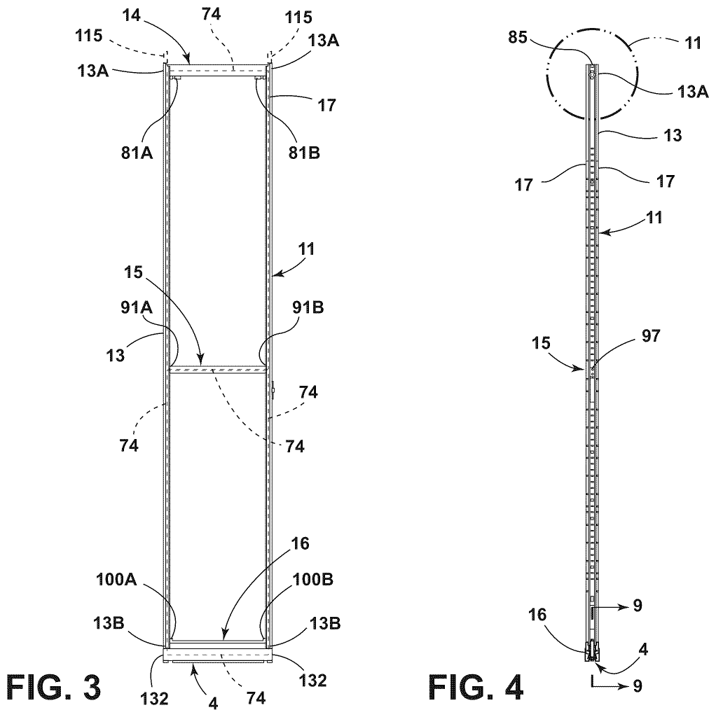

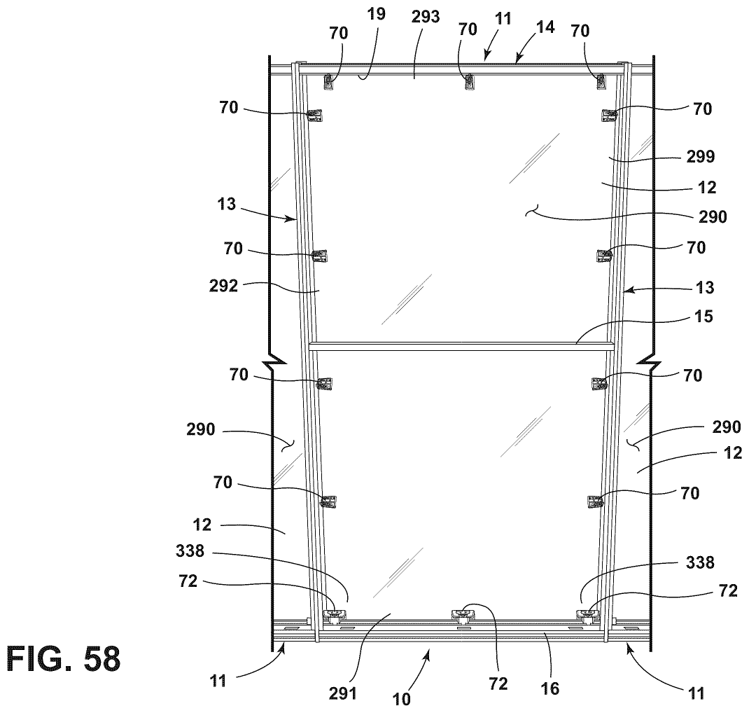

With further reference to FIGS. 2-4, solid wall panel 10 includes a rigid partition frame 11 including upright frame members or posts 13 that are rigidly interconnected by a generally horizontal upper frame member 14, one or more intermediate frame members 15, and a lower frame member 16. As discussed in more detail below in connection with FIGS. 58-65, panels 12 may be attached to frame 11 by one or more latches 70 and brackets 72. Also, resilient strips 74 may be adhesively secured to outer sides 17 of frame 11 to provide a biasing force acting outwardly on panels 12. Resilient strips 74 may comprise foam or other suitable material that provides a sealed or partially sealed connection between panels 12 and frame 11 around a perimeter of each panel 12. Resilient strips 74 may be positioned on the sides of posts 13 and frame members 14, 15, and 16 as shown in dashed lines in FIG. 3.

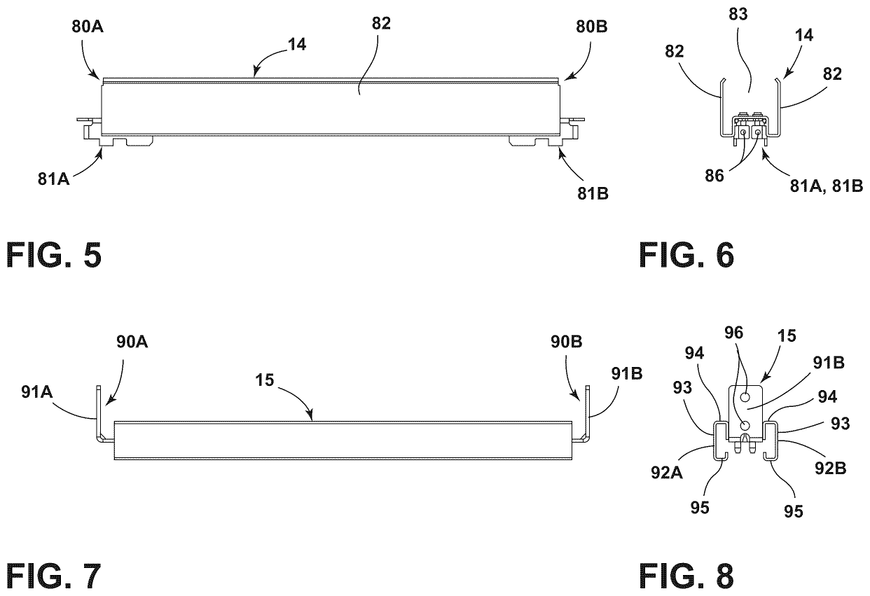

With reference to FIG. 5, the upper frame member 14 may include brackets 81A and 81B at opposite ends 80A and 80B, respectively of frame member 14. Sidewalls 82 (FIG. 6) of frame member 14 form an upwardly-opening channel 83. The walls 82 may be configured to receive resilient strips 74 to support the solid panels or skins 12 (FIG. 2) (i.e. to resist or prevent movement of panel 12 towards upper frame member 14). Frame member 14 may also include a bottom channel 19 (FIG. 58) that is engaged by one or more latches 70 to retain a panel 12 on frame 11. When assembled (FIG. 3), brackets 81A and 81B engage inner sides 18 of posts 13 at upper ends 13A of posts 13, and threaded fasteners 85 (FIG. 4) that are received in openings 86 of brackets 81A and 81B may be utilized to rigidly interconnect frame member 14 with posts 13. Alternatively, the frame member 14 may be rigidly interconnected to posts 13 by welding or other suitable connecting arrangement.

With reference to FIGS. 7 and 8, intermediate frame member 15 includes brackets 91A and 91B at opposite ends 90A and 90B. The intermediate frame member 15 includes outer portions 92A and 92B on opposite sides thereof. The outer portions 92A and 92B may be mirror images of one another, and may include an upright outer wall 93, and C-shaped upper and lower portions 94 and 95, respectively. The outer walls 93 may be configured to receive resilient strips 74 to support the panels or skins 12 (FIG. 2). When assembled, the brackets 91A and 91B may be rigidly secured to posts 13 by threaded fasteners 97 (FIG. 4) that are received in openings 96 of brackets 90A and 90B. Alternatively, the frame member 15 may be rigidly secured to the posts 13 by welding or other suitable connecting arrangement.

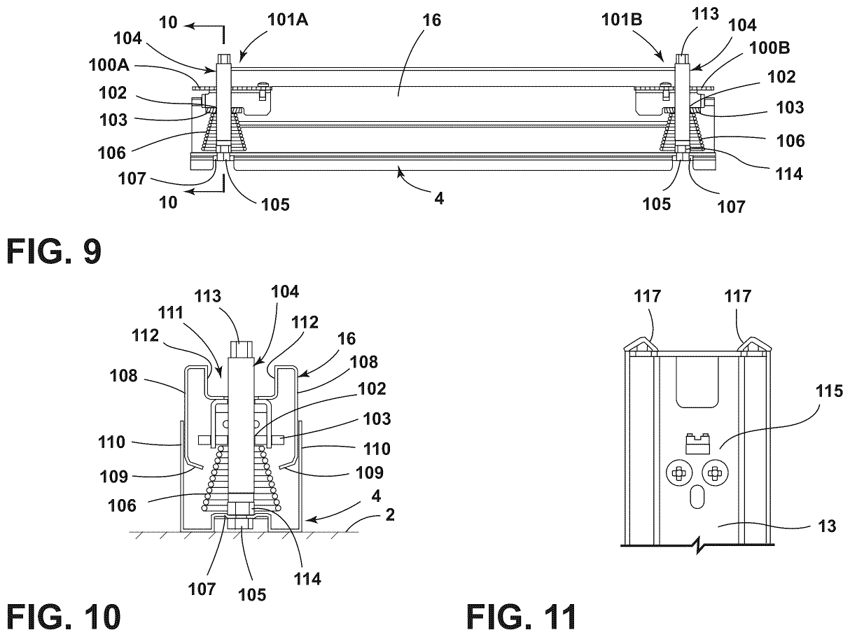

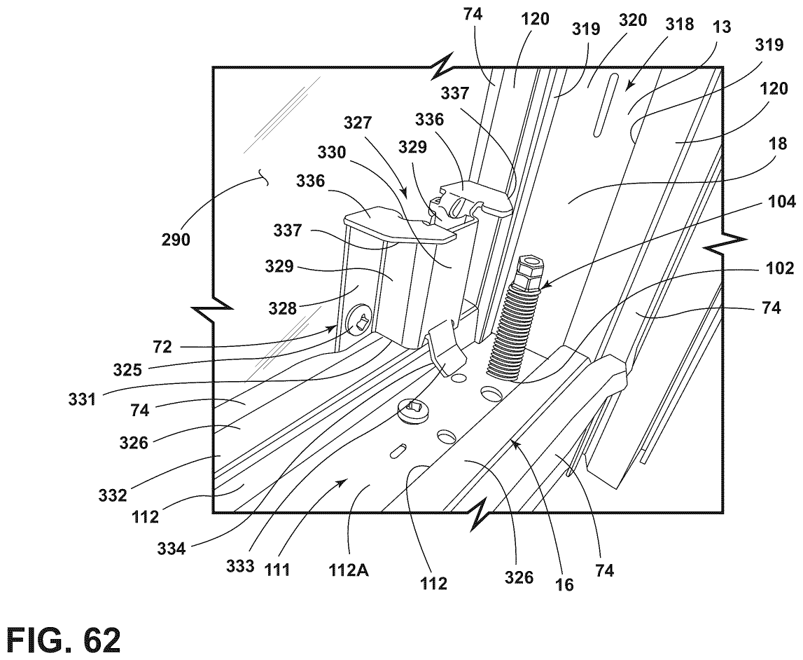

With further reference to FIGS. 9 and 10, lower frame member 16 includes bracket structures 100A and 100B at opposite ends 101A and 101B that rigidly secure the lower horizontal frame member to the posts 13 (see also FIG. 3). The lower frame member 16 may include upright outer sidewalls 108 having inwardly curved lower ends 109 that are received between outer sidewalls 110 of floor track 4 (FIG. 10). Lower frame member 16 also includes an upwardly opening channel 111 formed between sidewalls 112. When panels or skins 12 are secured to rigid panel frame 11, brackets 72 (FIGS. 62-64) are received in channel 111, and brackets 72 engage sidewalls 112 of lower frame member 16 to thereby retain a lower portion of the solid panels or skin 12 to the rigid panel frame 11.

Solid panel assembly 12 may include glide members 104 (FIGS. 9 and 10) that threadably engage threaded openings 102 of bracket 103, whereby rotation of glide members 104 causes the glide members 104 to shift vertically relative to lower frame member 16. The upper portions of glide members 104 may project upwardly into an interior space of wall panel 10 above lower frame structure (member) 16. However, because panels 12 are typically not light transmitting, the upper portions of glide members 104 are not visible from outside of solid wall panel 10. Springs 106 extend between floor track 4 and bracket 103, and bias floor track 4 into contact with floor 2. A lower end 105 of each glide member 104 extends through an opening 107 in floor track 4, and lower end 105 of glide member 104 directly contacts floor 2. Floor track 4 has a length that is approximately the same as lower frame member 16, and lower portion 105 of glides 104 may include a retainer (e.g. retainer 262, FIG. 50) to retain the floor track 4 against the bias of spring 106 such that the floor track 4 remains attached to panel 10 as panel 10 is moved into position (e.g. during installation). Wall panel 10 may also include a seal 242 (FIG. 51) on a lower side of floor track 4 to reduce transmission of noise under floor track 4. Glide members 104 may include one or more flat surfaces 113, 114. In use, a wrench may be utilized to engage the flat surfaces 113 and/or 114 to thereby rotate glide members 104 to adjust a vertical position of the solid panel 12 relative to the floor 2.

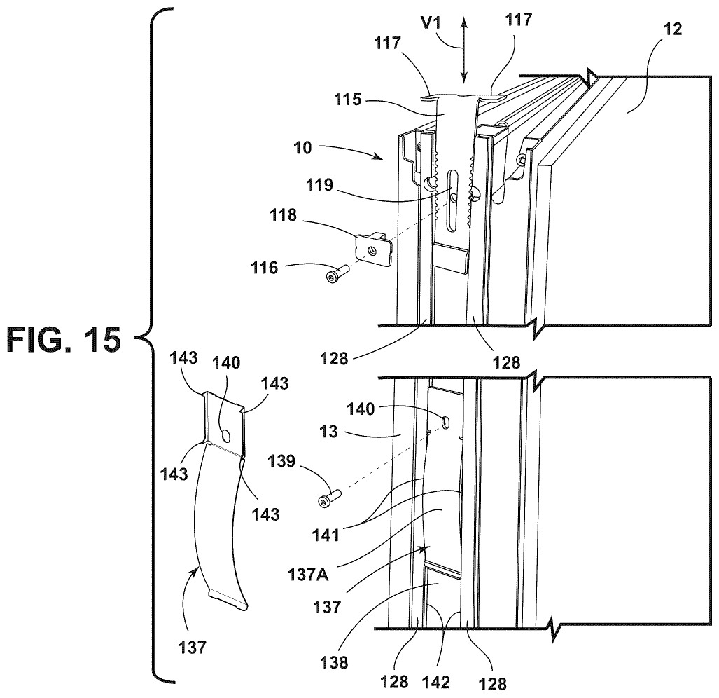

With further reference to FIGS. 11 and 15, solid wall panel 10 may include post extension brackets 115 that are attached to posts 13 adjacent the upper ends 13A (see also FIG. 3). The post extension brackets 115 may be secured to the posts 13 by one or more threaded fasteners 116. As shown in FIG. 15, posts extension bracket 115 may be secured to posts 13 by a bracket or clip 118 that is received in a vertical slot 119 of bracket 115, whereby the vertical position of bracket 115 can be adjusted as shown by the arrow “B1,” and threaded fastener 116 can then be tightened to secure the bracket 115 at the desired position. An alignment (planarity) clip 137 (or 137A) may be positioned in channel 138 formed between flanges 128, and the alignment clip 137 may be secured by a threaded fastener 139 that is received in an opening 140. Alignment clip 137 may optionally include a plurality of sharp spikes or hooks 143 that engage inner surfaces of flanges 128 to retain the alignment clip such that threaded fastener 139 is not required. A central portion 137A of alignment clip 137 curves outwardly, exposing edges 141 of alignment clip 137. When adjacent panels 10 are assembled at a vertical joint 8, the central portion 137A of alignment clip 137 is received in a channel 138 of an adjacent post 13 and edges 141 engage edges 142 of flanges 128 to thereby align the posts 13 of adjacent panels 10 at vertical joint 8. Typically, each panel 10 includes a single alignment clip 137, and an alignment clip 137 from an adjustment wall panel engages the opposite side edge of the panel. The threaded fasteners 116 may be loosened, and the post extension bracket 115 may be shifted upwardly so that an upper end 117 of post extension 115 engages ceiling track 5 (see also FIG. 2). The threaded fasteners 116 may then be tightened to secure the post extension bracket 115 in the upper position whereby the post extension brackets 115 maintain alignment of the solid wall panel 10 with ceiling track 5 (i.e. center wall panel 10 below ceiling track 5).

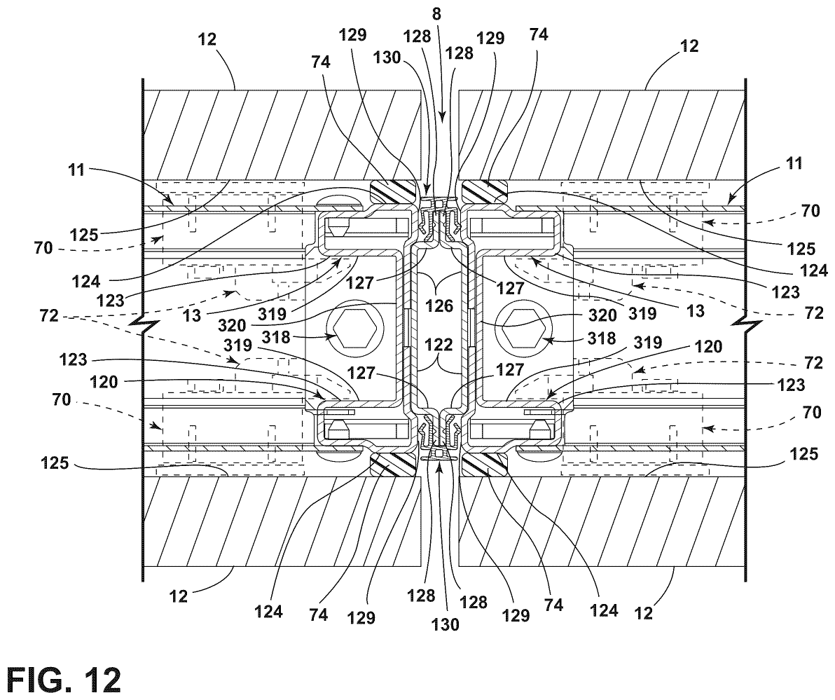

With further reference to FIG. 12, each post 13 includes an upright structure 120 and a connecting structure 122. The connecting structure 122 may be integrally formed with the upright structure 120, or the connecting structure 122 may comprise a separate channel structure that is secured to the upright structure 120 by welding, fasteners, or the like. Each upright structure 120 includes tubular outer portions 123 including outer side surfaces 124. Resilient strips 74 may be adhesively secured to the outer side surfaces 124 to thereby fill gaps that might otherwise exist between inner surfaces 125 of panels 12 and outer surfaces 124 of upright structures 120.

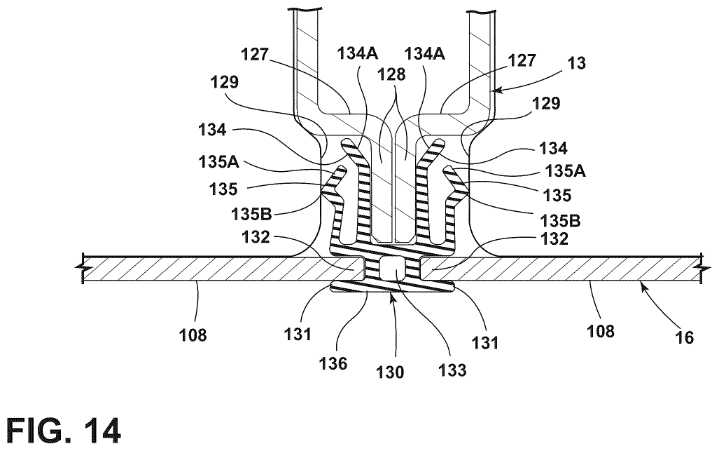

The connecting structures 122 include a first web or wall 126, transverse flanges 127, and outwardly extending flanges 128. When a pair of adjacent solid wall panels 10 are positioned next to one another, the outward flanges 128 of the adjacent posts 13 abut one another, and resilient frame couplers 130 are positioned on the flanges 128 to thereby interconnect the adjacent wall panels 10 at vertical joint 8. The resilient frame couplers 130 are also discussed below in connection with FIG. 14.

Referring again to FIG. 12, each upright post 13 includes a pair of tubular outer portions 123 having inner surfaces 319 that face one another (see also FIG. 64). The upright posts 13 further include a base surface 320 that extends between the surfaces 319 of the tubular outer portions 120. The surfaces 319 and 320 form a vertically extending channel 318 on the inner sides 18 of vertical posts 13.

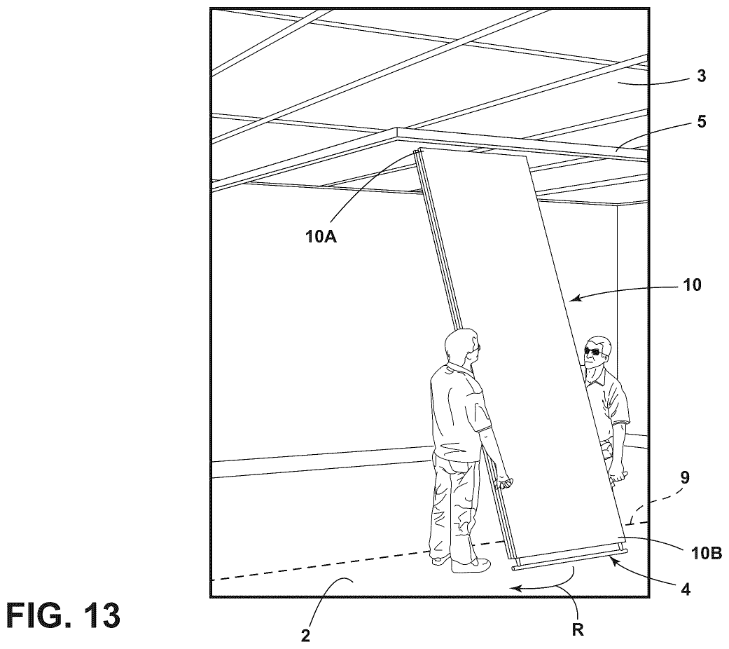

With further reference to FIG. 13, during installation, a ceiling track 5 may be secured to a ceiling 3. Ceiling track 5 may have a length that is significantly greater than the width of wall panel 10 such that a single ceiling track 5 may extend across several adjacent wall panels 10, 20, 30, etc. An upper portion 10A of a wall panel 10 may then be positioned in the ceiling track 5, and a lower portion 10B of wall panel 10 may be rotated as shown by the arrow “R” until the wall panel is in a vertical position directly below ceiling track 5. The wall panel 10 may then be lowered into the floor 2 such that floor track 4 is positioned directly below ceiling track 5 in a position shown by dashed line 9. Extension brackets 115 may then be shifted upwardly into engagement with ceiling track 5. It will be understood that the glass wall panels 20 and 30, and clerestory wall panel 40 may be installed in substantially the same manner as shown in FIG. 13.

As discussed above in connection with FIG. 12, resilient frame couplers 130 engage adjacent outer flanges 128 of adjacent posts 13 to interconnect a pair of panels 10 at a joint 8. With further reference to FIG. 14, resilient frame coupler 130 includes oppositely opening channels or grooves 131 that may receive vertical edge portions 132 of outer walls 108 of lower frame member 16. For example, a single resilient frame coupler 130 may extend from upper ends 13A (FIG. 3) of posts 13 to bottom end portions 13B of posts 13, and down along vertical edges 132 to thereby close off gap 133 between edges 132 (FIG. 14) of adjacent panels 10. As shown in FIG. 14, the frame coupler 130 may comprise a flexible polymer material, and may include a pair of inner flanges or legs 134 that engage adjacent flanges 128 of posts 13. The frame coupler 130 may also include outer flanges 135 that engage surfaces 129 of posts 13. Inner flanges 134 include outwardly-angled end portions 134A to facilitate positioning of the frame coupler 130 on flanges 128. Similarly, outer flanges 135 include angled end portions 135A that facilitate insertion of frame coupler 130, whereby outer portions 135B of outer flanges 135 engage surfaces 129 of adjacent posts 13. Outer web 136 of frame coupler 130 may be relatively thin to provide a smooth appearance at the lower portion of vertical joint 8.

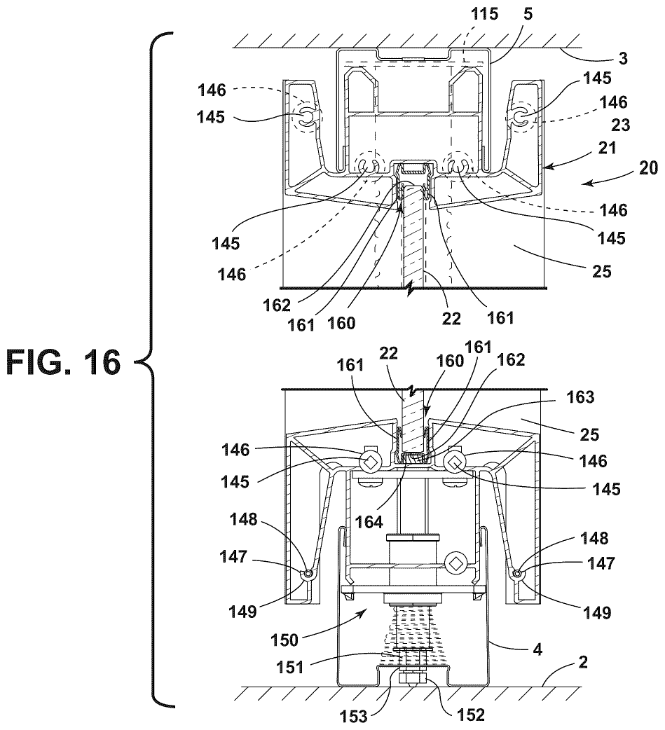

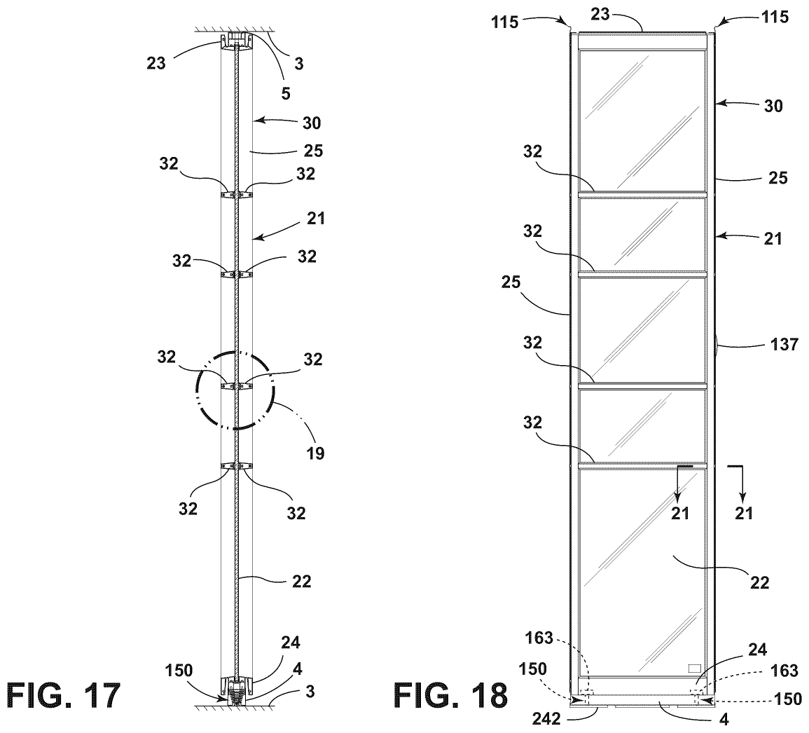

FIG. 16 is a cross sectional view of the glass wall panel 20 of FIG. 1. As discussed in more detail below, wall panel system 1 may also include a glass wall panel 20A that may be assembled onsite. FIG. 17 is a cross sectional view of the glass panel 30 of FIG. 1 taken along the line 17-17. The construction of glass wall panel 20 and glass wall panel 30 is similar, except that the glass wall panel 30 further includes horizontal members or muntins 32 that are disposed on opposite sides of sheet 22.

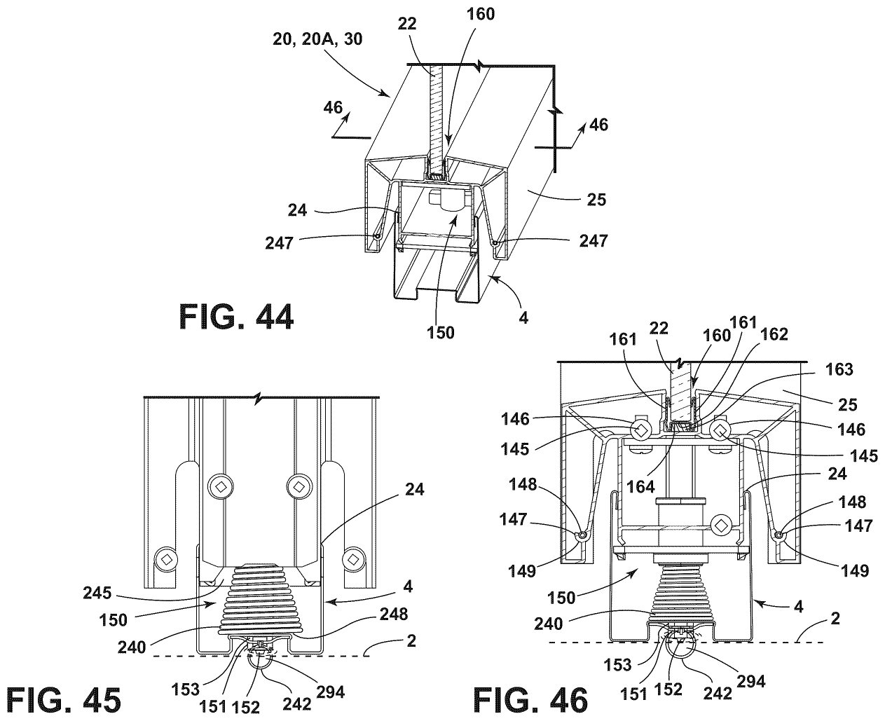

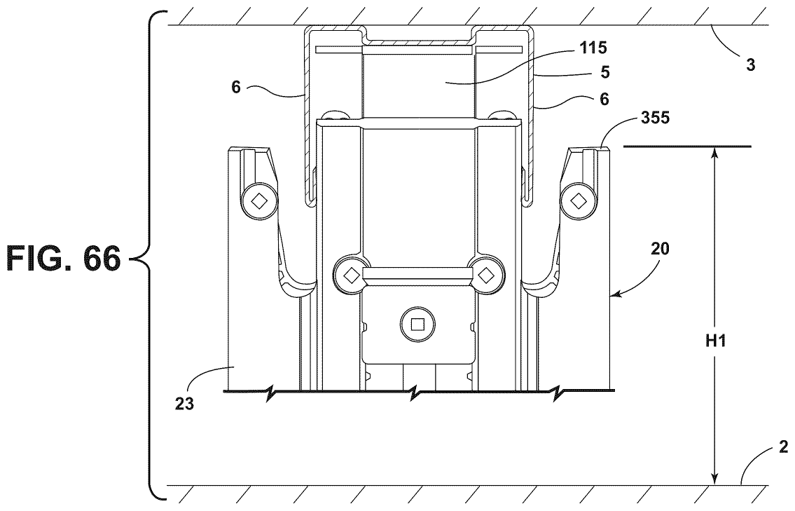

Referring again to FIG. 16, glass wall panel 20 includes an upper frame member 23 and extension bracket 115 that engages ceiling track 5, and lower frame member 24 that engages floor track 4 (see also FIG. 66). Floor track 4 may be retained to glass wall panel 20 by glide assemblies 150 (FIGS. 44-53). Glass wall panel 20 may include a post extension bracket 115 that is substantially similar to the post extension bracket 115 of FIG. 15. Glass wall panel 20 may further include an alignment bracket 137 (FIG. 18) that is substantially similar to the alignment bracket 137 of FIG. 15.

As discussed above, glass wall panels 20 and 30 may include a sheet 22 comprising glass or other light-transmitting material (e.g. polymer). However, the sheet of material 22 may, alternatively, comprise an opaque material, or a material that is only partially light-transmitting. Accordingly, it will be understood that the term “glass wall panel” does not mean that the sheet of material 22 is limited to a glass material.

The glass wall panels 20 and 30 may be preassembled at a production facility or the like, and the panels may then be installed as discussed above in connection with FIG. 13.

As discussed in more detail below in connection with FIGS. 44-53, a glide assembly 150 may include a shaft 151 having a lower end 152 that passes through an opening 153 in floor track 4 such that the lower end 152 of shaft 151 directly contacts floor 2, to thereby adjustably support a vertical position of the glass wall panel 20 relative to the floor 2. Glides 150 also retain the floor track 4 to the glass wall panel 20, such that floor track 4 can be moved into position on floor 2 during installation as shown in FIG. 13. The upper and lower frame members 23 and 24 may comprise metal (e.g. aluminum) extrusions having integrally-formed screw bosses 145 that receive threaded fasteners 146 to rigidly interconnect the upper and lower frame members 23 and 24, respectively, to the post 25. The upper and lower frame members 23 and 24 may also (optionally) include one or more pin bosses 147 that receive pins 148 that are received in the openings 149 of post 25 to position and align upper and lower frame members 23 and 24, respectively, with post 25. Typically, frame members 23 and 24 include only screw bosses 145, and pins are not utilized when frame members 23 and 24 are configured in this way. It will be understood that the frame members 23, 24, and post 25 may be interconnected utilizing virtually any suitable connecting arrangement to form a rigid frame 21, and the present disclosure is not limited to the specific arrangement of FIG. 16.

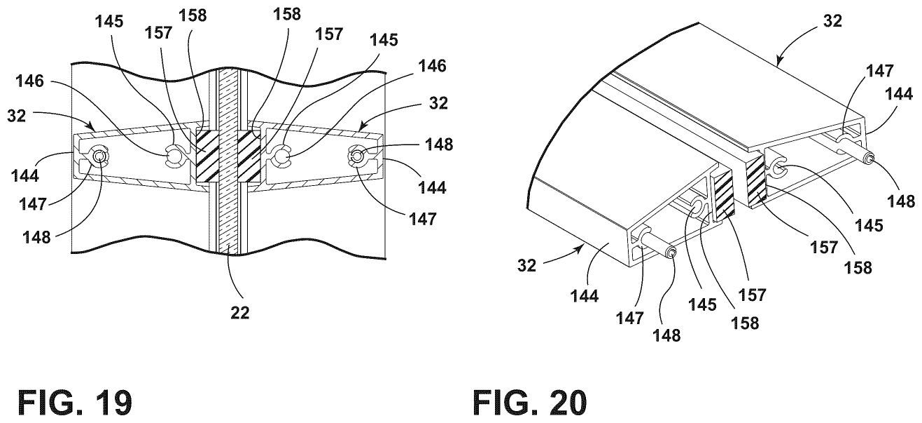

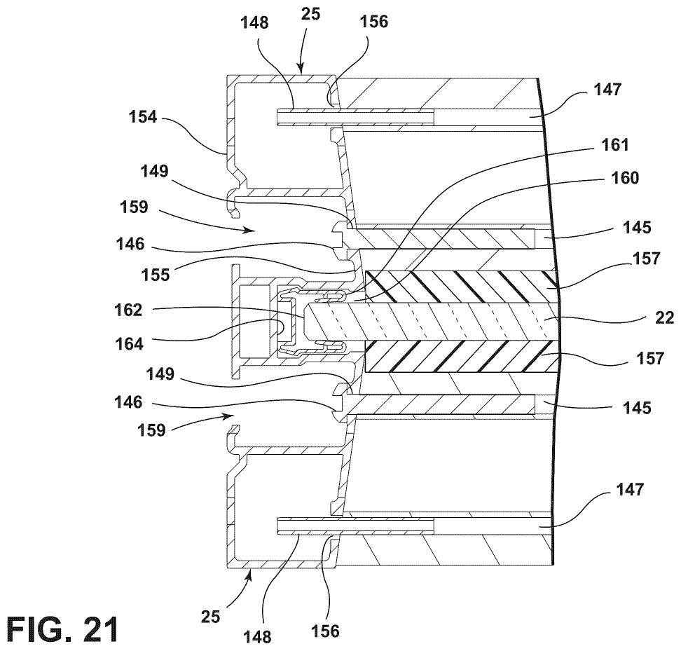

With further reference to FIGS. 17-21, glass wall panel 30 may include a frame 21 comprising upper and lower frame members 23 and 24, respectively, that are rigidly interconnected to post 25 in substantially the same manner as described above in connection with FIG. 16. The glass panel 30 further includes a plurality of horizontal muntins 32 that are disposed on opposite sides of sheet 22. With reference to FIGS. 19 and 20, the muntins 32 may comprise elongated rigid aluminum extrusions having screw bosses 145 that receive screws 146, and pin bosses 147 that receive pins 148. Pins 148 may have a smaller diameter than screws 146, and pin openings 156 in post 25 are therefore smaller than screw openings 149, such that pins 148 and openings 156 are less visible than screws 146 and screw openings 149. Pins 148 may be utilized adjacent outer sides 144 of muntins 32 to provide reduced visability. As shown in FIG. 21, screws 146 may extend through screw clearance openings 149 in sidewall 155 of post 25. If post 25 is configured to be used in a glass wall panel 30 having muntins 32, sidewall 154 of post 154 may include openings 159 that are generally aligned with openings 149 to thereby permit access to screws 146. Similarly, pins 148 may extend through openings 156 in sidewall 155 of post 25. It will be understood that the post 25 will not normally include openings 149 and 156 if the post 25 is used in a glass wall panel 20 (FIGS. 1 and 16) that does not include muntins 32. Referring again to FIGS. 19-21, elongated foam strips 157 may be positioned in channels 158 of muntins 32. The foam strips 157 are preferably dimensioned such that the foam strips 157 are compressed somewhat by the sheet 22 when glass wall panel 30 is assembled.

Referring again to FIG. 16, upper and lower frame members 23 and 24, respectively, of glass wall panels 20 and 30 include channels 160 that receive flexible seals 161. Similarly, posts 25 of glass wall panels 20 and 30 also include channels 160 that receive seals 161. When assembled, edges 162 of sheets 22 are received in seals 161 in channels 160. Resilient glazing blocks 163 may be disposed in channel 160 of lower frame member 24 to support sheet 22. In general, glazing blocks 163 may be positioned above glide 150. Thus, the glazing blocks 163 do not necessarily extend along the entire length of lower frame member 24. In general, the glazing blocks 163 may be positioned between a base surface 164 of channel 160 and seal 161. Glazing blocks 163 may be positioned in channels 160 of upper and lower frame members 23 and 24, respectively, and in both posts 25 of a glass wall panel 20 or 30. Alternatively, the glazing blocks 163 may only be positioned in channel 160 of lower frame member 24.

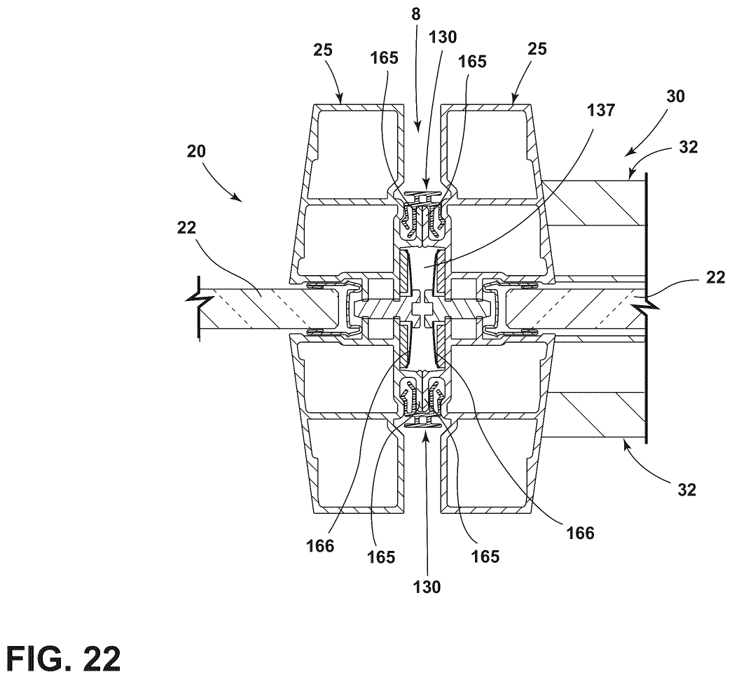

With further reference to FIG. 22, a vertical joint 8 between glass panels 20 and 30 is formed by positioning adjacent posts 25 in alignment with one another. Resilient frame couplers 130 are then positioned on flanges 165 of adjacent posts 25. An alignment clip 137 may be secured to a selected one of the posts to thereby insure that the vertically extending channels 166 of the adjacent posts 25 are aligned with one another. The alignment clip 137 may have substantially the same configuration as alignment clip 137 of FIG. 15.

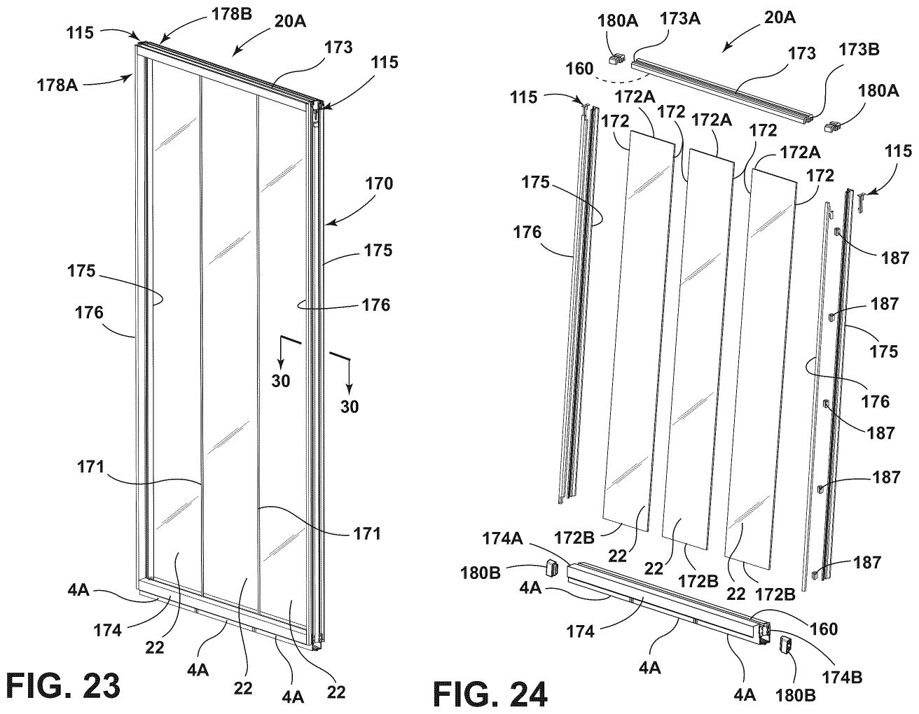

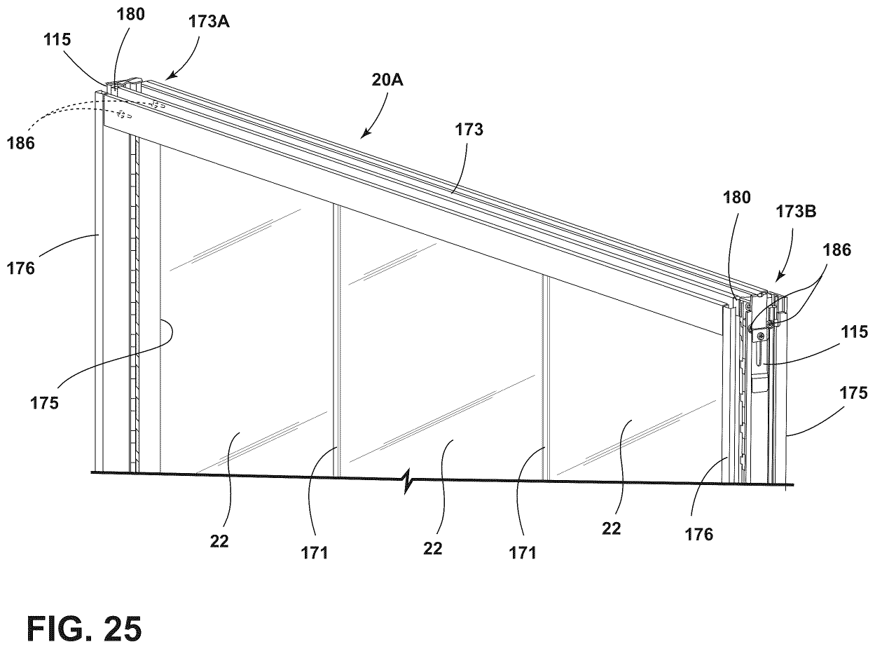

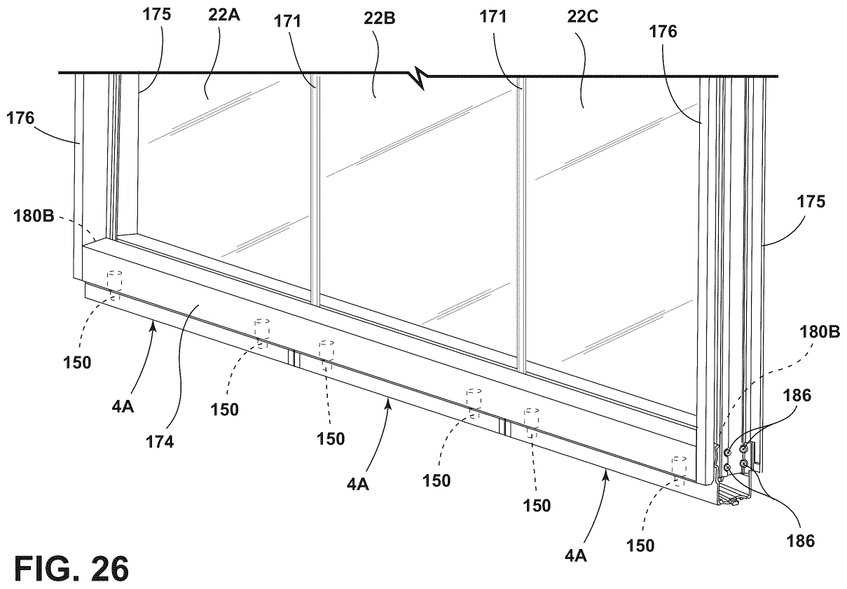

With further reference to FIGS. 23-28, a glass wall panel 20A according to another aspect of the present disclosure includes a frame 170 that may be assembled onsite. The glass wall panel 20A may include one or more sheets of material 22 (e.g. sheets 22A, 22B, 22C) disposed adjacent one another with edges 172 (see also FIG. 24) that abut one another to form vertical seams or joints 171. The rigid frame 170 includes an upper frame member 173, lower frame member 174, and upright frame members 175. The upright trim members 176 have a profile that is substantially identical to the profile of upright frame members 175 to provide a substantially identical appearance on first and second opposite sides 178A and 178B of glass wall panel 20A. However, as discussed in more detail below, the upright trim members 176 do not retain the sheets 22. The glass wall panel 20A may include a single lower frame member 174 and a plurality of individual floor track sections 4A. The number of floor track sections 4A may be equal to the number of sheets of material 22, and the length of each floor track segment 4A may be about the same as the width of a sheet of material 22 positioned above the individual floor track section. Each floor track segment 4A may be engaged by a pair of glides 150 (FIG. 26), such that each sheet of material 22 is supported by a pair of glides 150. However, fewer slides 150 may also be utilized. For example, the glides 150 below the center sheet 22B of FIG. 26 are optional, whereby the panel 20A has two glides 150 under each outer sheet 22A, 22B, but no glides under center sheet 22B.

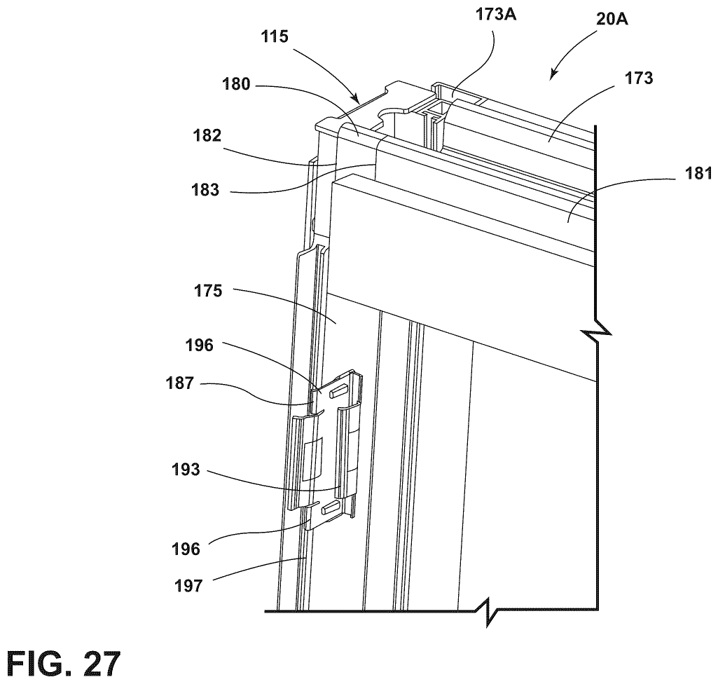

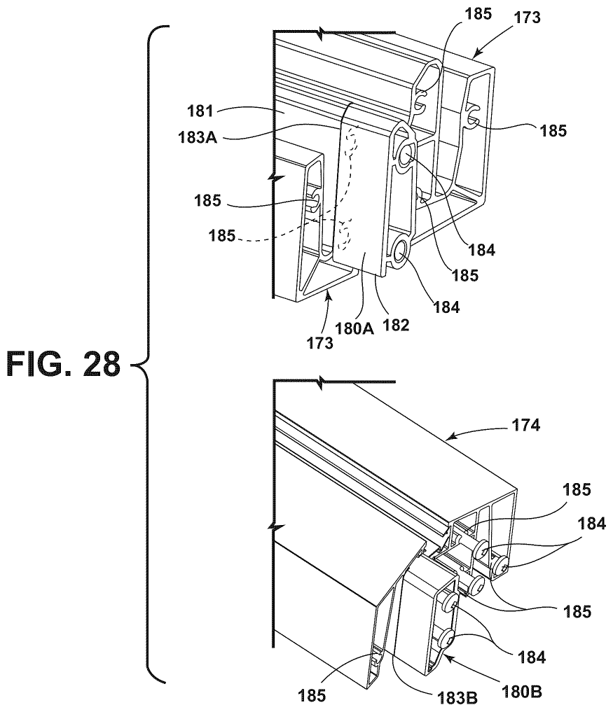

With reference to FIGS. 27 and 28, during assembly spacers 180A are positioned adjacent opposite ends 173A and 173B of upper frame member 173 to extend the surface or outer profile 181 of upper frame member 173, and spacers 180B may be positioned adjacent opposite ends 174A and 174B of lower frame member 174 to extend its profile. The outer surface or profile 182 of spacers 180A is substantially identical to the outer surface or profile 181 of upper frame member 173 to thereby provide a substantially continuous appearance. Although seams or joints 183A and 183B are formed by spacers 180A and 180B, the joints 183A and 183B are not visually obtrusive due to the matching surface profiles. The spacers 180A and 180B may be secured to upper and lower frame members 173 and 174, respectively, by threaded fasteners 184 that are received in screw bosses 185 of frame members 173 and 174. As shown in FIG. 28, the lower frame member 174 may have a profile and cross-sectional shape that is substantially similar to the lower frame member 24 of glass wall panel 20 (FIG. 16).

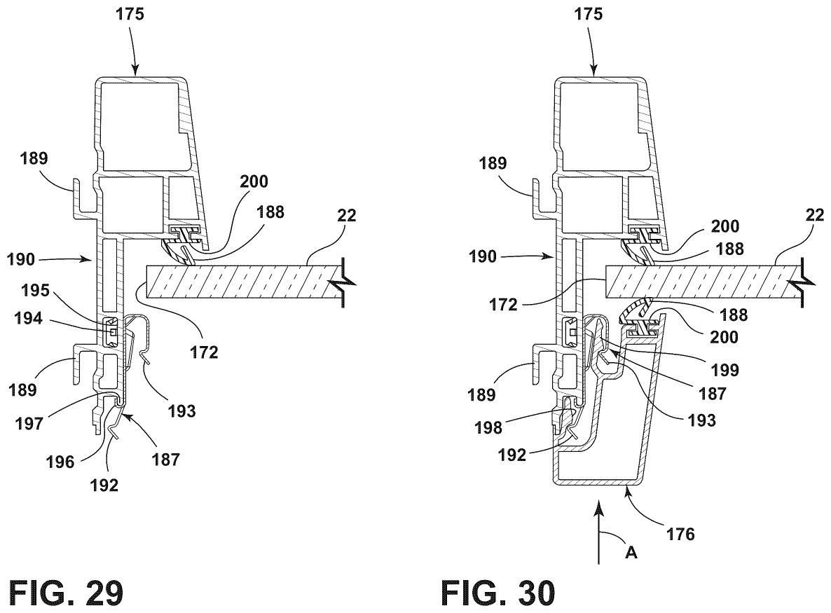

During assembly of glass wall panel 20A, after the spacers 180A and 180B are secured to opposite ends of frame member 173 and 174, the upright frame members 175 are secured to the upper and lower frame members 173 utilizing screws 186 (FIGS. 25 and 26) that are received in screw bosses 185 (FIG. 28) of upper frame member 173, and screw bosses (e.g. screw bosses 145) of lower frame member 174. Upper and lower frame members 173 and 174 may include channels 160 that are substantially identical to the channels 160 of upper and lower frame members 23 and 24, respectively (FIG. 16), and the channels 160 may receive seals 161. Glazing blocks 163 may be positioned in channel 160 of lower frame member 174. For example, a glazing block 163 may be positioned in channel 160 of lower frame member 174 adjacent each lower corner of the sheets of material 22. After the upper and lower frame members 173 and 174, respectively are interconnected to the upright frame members 175, the sheets of material 22 may be positioned in the frame 170 by inserting upper edges 172A of sheets 22 in channel 160 of upright frame member 173. The sheets 22 can then be rotated to a vertical position above channel 160 in lower frame member 174, and the individual sheets of material 22 can then be shifted downwardly so that the lower edge 172B of each sheet 22 is received in channel 160 of lower frame member 174. As shown in FIG. 29, at this stage of the assembly process the sheets of glass 22 are vertically positioned and retained by the upper frame member 173 and lower frame member 174. As shown in FIG. 29, the upright frame members 175 do not include a channel 160, such that a vertical edge of 172 of sheet 22 adjacent upright frame member 175 is not positioned or received in a channel 160.

With further reference to FIG. 30, trim members 176 are then connected to upright frame members 175. Specifically, a plurality of retaining clips 187 are initially secured to upright frame members 175 by inserting retainers 194 of clips 27 into openings 195 of upright frame member 175, with hooked portion 196 of clip 187 engaging lip 197 of upright frame members 175. Clips 187 include first and second resilient arms 192 and 193, respectively. Referring again to FIG. 30, the upright trim members 176 are installed by shifting the upright trim members in the direction of the arrow “A,” thereby causing first and second barbed flanges 198 and 199, respectively, of upright trim member 176 to engage first and second retaining legs 192 and 193, respectively, of clips 187. A plurality of the clips 187 may be secured to upright frame members 175 at spaced apart locations (e.g. FIG. 24). Referring again to FIG. 30, resilient seals 188 may be positioned in channels 200 of upright frame members 25 and channels 200 of trim members 176. The resilient seals 188 engage opposite sides of the sheet of material 22.

As shown in FIGS. 29 and 30, the upright frame members 25 may include flanges 189 in a channel 190 having substantially the same configuration as flanges 165 and channel 166 of upright frame members 25 (FIG. 22). Accordingly, the glass wall panel 20A may be interconnected with adjacent panels 10, 20, 20A, etc. utilizing resilient frame couplers 130 and alignment clips 137.

As discussed above, the glass partition panel 20A may include a plurality of sheets of material 22. Alternatively, panel 20A may include a single sheet of material 22, and a plurality of sheets of material 22 are not required. A plurality of smaller sheets 22 may be preferable if panel 20A is a very large panel. For example, a very large panel 20 having a very large single sheet of material 22 (e.g. glass) may be quite heavy, making it difficult to transport and/or install a large pre-assembled glass panel 20. Because the glass panel 20A can be assembled on site utilizing a plurality of sheets of material 22 (e.g. glass) having a smaller size, the panel 20A may have a very large overall size. Also, because the vertical edges 172 of adjacent sheets of material 22 are positioned directly adjacent one another, or abutting one another, the visual impact of vertical seams 171 (FIG. 23) is reduced.

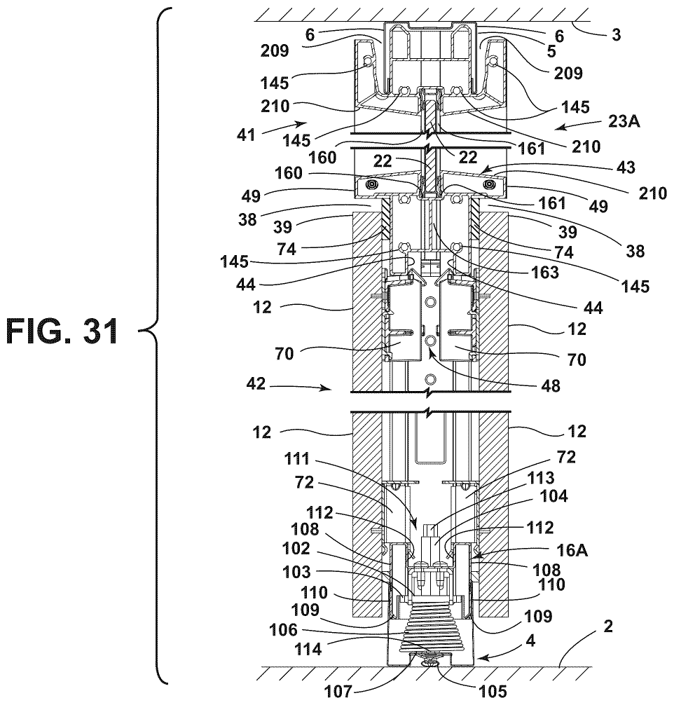

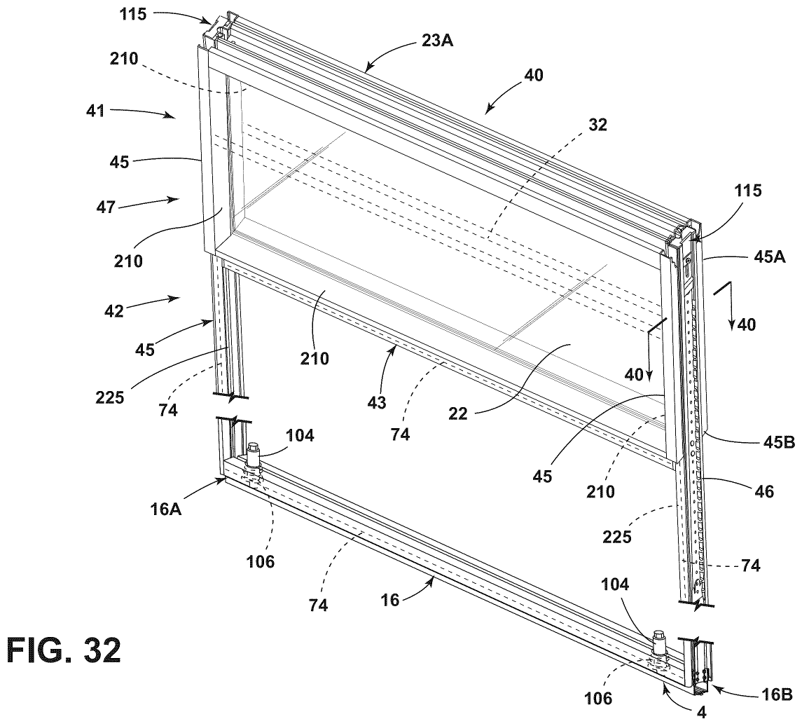

With further reference to FIG. 31, clerestory wall panel 40 includes an upper portion 41 having a light-transmitting sheet of material 22, and a lower portion 42 having solid panels 12. Upper portion 41 may include an upper frame member 23 that is substantially similar to the upper frame member 23 of glass wall panel 20 as discussed above in connection with FIG. 16. Lower portion 42 of clerestory panel 40 may include a lower frame member 16 and floor track 4 (FIG. 32) that is operably connected to lower frame member 16 by glides 104 in a manner that is substantially similar to the solid wall panel 10 (FIGS. 9-10). Clerestory wall panel 40 further includes an intermediate frame member 43 having an upwardly opening channel 160 that is configured to receive a seal 161 and optional glazing blocks 163 to support a sheet of material such as glass 22. Intermediate frame member 43 further includes panel support structure such as surfaces 44 of channel 48 (see also FIG. 36) that is configured to engage with latches 70 to retain wall panels 12 below intermediate frame member 43. The panels 12 may be mounted to the lower portion 42 of clerestory wall panel 4 utilizing latches 70 and brackets 72 in substantially the same manner discussed in more detail below in connection with FIGS. 58-64.

With further reference to FIGS. 32-36, upper portion 41 of clerestory wall panel 40 includes an upper frame 47 including upper frame member 23A, intermediate frame member 43, and a pair of upright frame members 45. When assembled, upright frame members 45 are interconnected with upper frame member 23A and intermediate frame member 43. When clerestory wall panel 40 is assembled, the upper frame 47 is rigidly secured to a pair of spaced apart posts 46. The posts 46 extend between upper frame member 23A and lower frame member 16, such that the upper and lower portions 41 and 42, respectively, of clerestory wall panel 40 are rigidly interconnected. When installed, the clerestory wall panel 40 is therefore supported on floor 2 by glides 104 with the upper portion of clerestory wall panel 40 engaging ceiling track 5. As shown in FIG. 32, the floor track 4 has a length that is approximately equal to a width of clerestory wall panel 40.

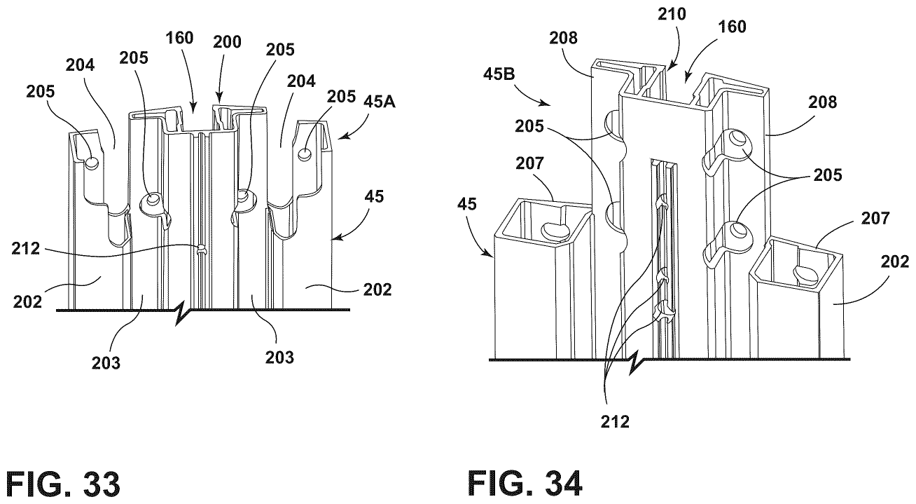

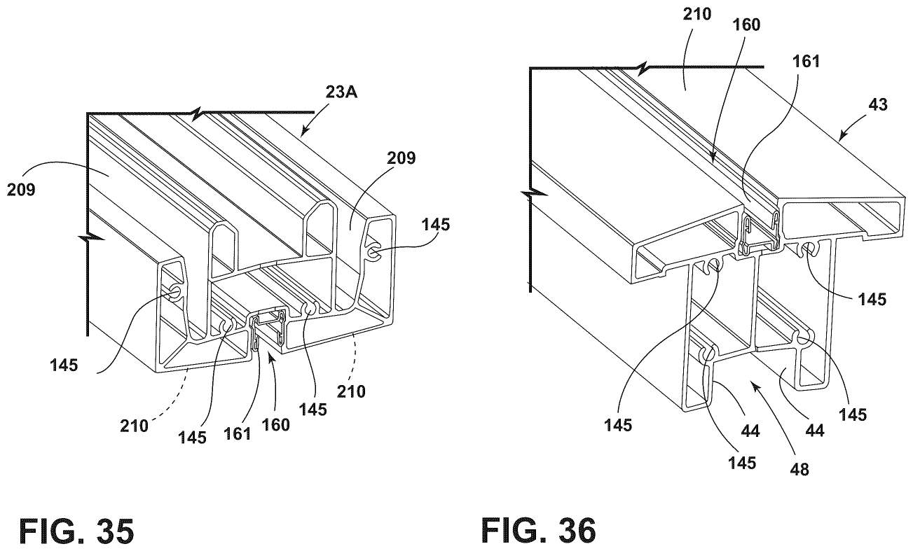

With further reference to FIG. 33, upper end 45A of each upright frame member 45 includes a central portion 200 having a channel 160, and a pair of spaced apart outer tubular portions 202. Outer tubular portions 202 are spaced apart from central portion 200 to form channels 203 that face outwardly when upper frame 47 is assembled. The upper end 45A further includes cutouts 204 that provide clearance for sidewalls 6 of ceiling track 5 (FIG. 31) when panel 40 is assembled and installed. Upper end 45A further includes a plurality of clearance openings 205 that are configured to receive threaded fasteners that extend into screw bosses 145 of upper frame member 23A (FIG. 35).

With further reference to FIG. 34, the lower ends 45B of each upright frame member 45 includes a plurality of clearance openings 205 that receive threaded fasteners, whereby the threaded fasteners engage screw bosses 145 of intermediate frame member 43 (FIG. 36) when the lower end 45B of upright frame member 45 is assembled to the intermediate frame member 43. Lower ends 207 of tubular portions 202 are cut away, such that the lower end 45B of upright frame member 45 has a contour that generally matches the contour of intermediate frame member 43 when assembled (see also FIG. 38).

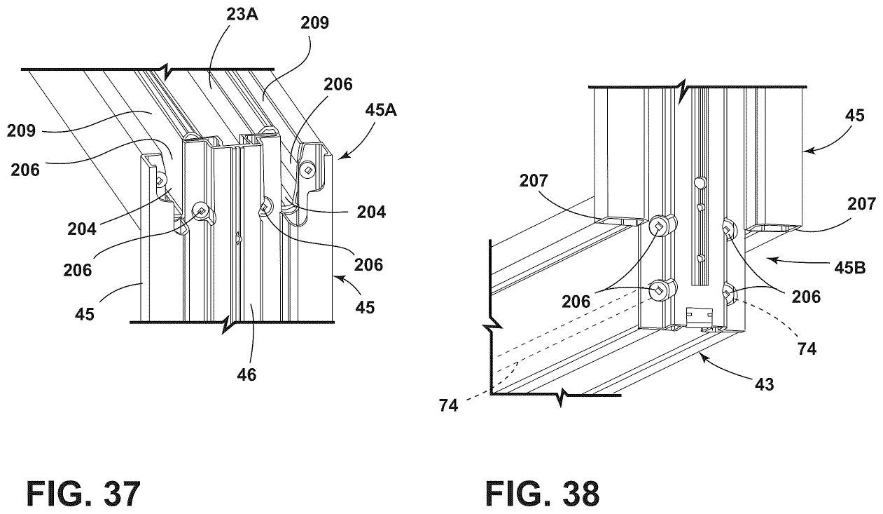

With further reference to FIG. 37, during assembly of upper frame 47 of clerestory wall panel 40, upper ends 45A of upright frame members 45 are secured to opposite ends of upper frame member 23 utilizing threaded fasteners 206 that are received in screw bosses 145 of upper frame member 23A. As shown in FIG. 38, lower ends 45B of upright frame members 45 are secured to opposite ends of intermediate frame member 43 utilizing fasteners 206 that engage screw bosses 145 of intermediate frame member 43. As shown in FIG. 37, when upright frame members 45 are assembled with upper frame member 23A, the cutouts 204 of upright frame member 45 align with upwardly opening channels 209 of upper frame member 23A. When clerestory panel 40 is installed (FIG. 31), the sidewalls 6 of ceiling track 6 extend into the channels 209 of upright frame member 23A, and into the cutouts 204 of upright frame member 45.

During assembly of upper frame 27, edges of sheet 22 are positioned in channels 160 of frame members 23A, 43, and 45 prior to final assembly, such that the sheet 22 is retained in upper frame 47 upon assembly of frame members 23A, 43, and 45. The surfaces 210 of each frame member 23A, 43, and 45 extend along opposite sides of each channel 160. Surfaces 210 may have substantially the same profile, and the appearance of the upper portion 41 of clerestory panel 40 (FIGS. 32) may be substantially similar to the appearance of glass wall panels 20 and 30. The upper portion 41 of clerestory wall panel 40 may optionally include one or more muntins 32 that may be substantially similar to the muntins 32 of glass wall panel 30. More specifically, the upright frame members 45 may include one or more openings that receive threaded fasteners and/or pins to thereby interconnect a muntin 32 in substantially the same manner as described above in connection with the glass wall panel 30.

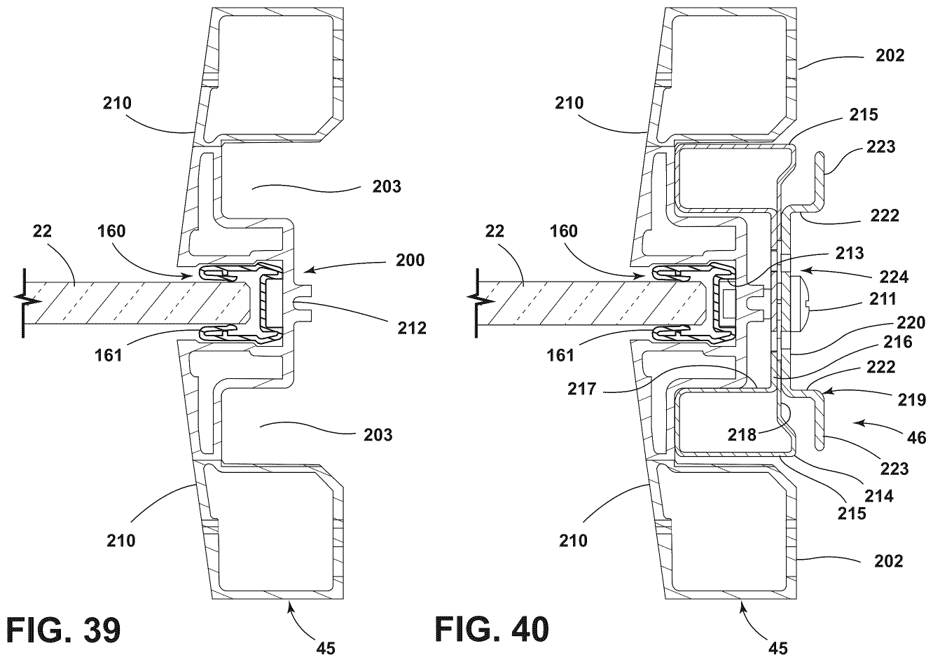

With further reference to FIG. 39, after initial assembly of frame 47, glass 22 is retained in channels 160 of upright frame members 45. Posts 46 may then be secured to upright frame members 45 utilizing threaded fasteners 211 that may be received in threaded openings 212 of upright frame members 45. The threaded openings 212 may be formed by a threaded insert 213 (FIG. 40). Post 46 includes a first member 214 having spaced apart tubular outer portions 215 that are received in channels 203 (FIG. 39) of upright frame members 45. Upright 215 further includes a central portion 216 extending between and interconnecting tubular outer portions 215. Central portion 216 may comprise overlapping webs 217 and 218. Post 46 further includes a connecting rail member 219 that is secured to the first member 214. Connecting rail member 219 includes a central web 220 that overlaps the webs 217 and 218 of first member 214, transverse webs or walls 222, and outwardly extending flanges 223. The outwardly extending flanges 223 permit the post 46 to be attached to adjacent wall panels 10, 20, 30, etc. utilizing resilient frame couplers 130 (e.g. FIG. 12) and alignment clips 137 (e.g. FIG. 15) that are received in channels 224 of post 46.

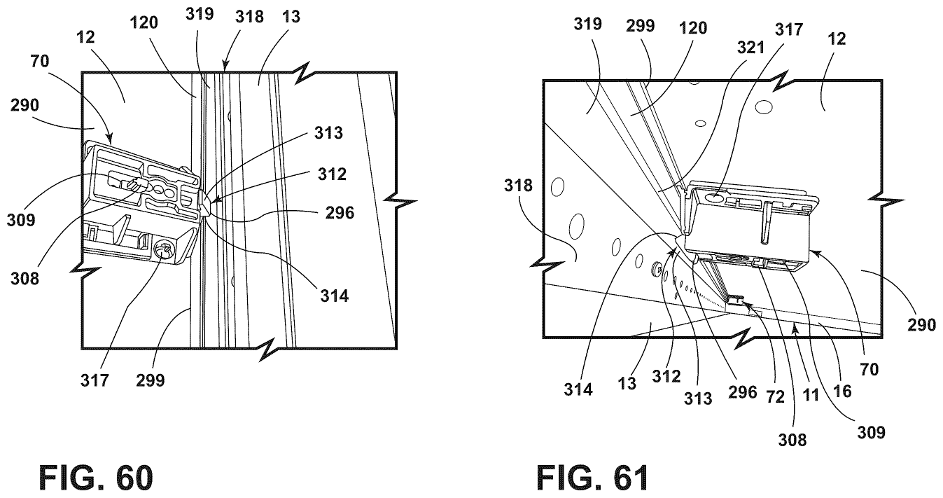

Referring again to FIG. 32, clerestory panel 40 includes a lower frame member 16 that is substantially similar to the lower frame member 16 described above in connection with FIGS. 2-4 and FIGS. 9-10. Brackets 72 may engage lower frame member 16 of clerestory panel 40 in substantially the same manner shown in FIG. 62. The posts 46 of clerestory panel 40 may have an inwardly facing side 225 having a configuration that is substantially similar or identical to the inwardly facing sides 18 of post 13 (FIGS. 2 and 3) of wall panel 10. Thus, lower frame member 16 of clerestory panel 40 can be attached to posts 46 in substantially the same manner as the lower frame member 16 is attached to posts 13 of wall panel 10. Also, latches 70 may engage inner sides 225 of posts 46 in substantially the same manner shown in FIGS. 60 and 61. Also, as shown in FIG. 31, one or more latches 70 may be mounted to panel 12 adjacent an upper edge thereof. These latches 70 may engage surfaces 44 of channel 48 (FIG. 36) of intermediate frame member 43 to thereby connect the upper portions of panels 12 to intermediate frame member 43. As shown in FIG. 31, outer surfaces 39 of panels 12 may be substantially coplanar with outer surfaces 49 of frame member 43. The upper edges of panels 12 may be spaced apart from the lower surfaces of intermediate frame member 43 to form gaps 38. Gaps 38 are preferably small (e.g. ⅛″, ¼″, ⅜″, etc.) Gaps 38 preferably have the same dimension as the vertical gaps between adjacent panels 12 at a vertical joint 8 (FIG. 12).

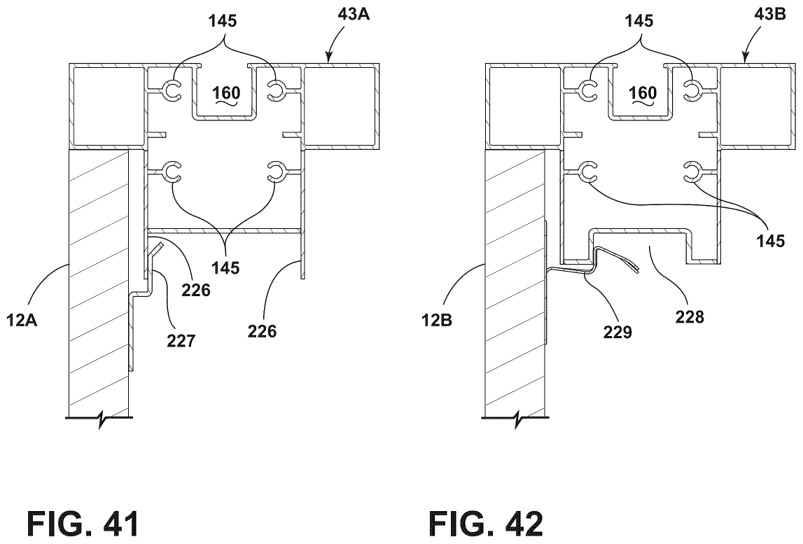

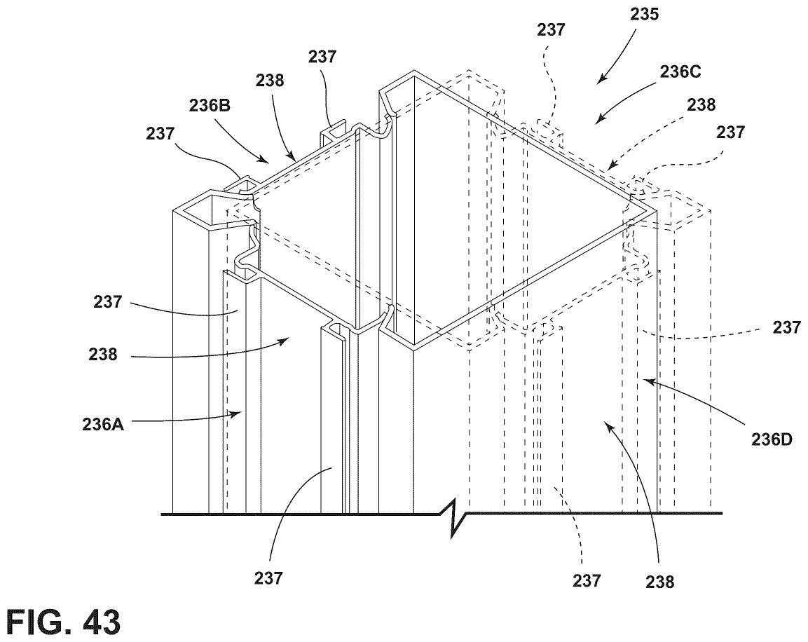

FIGS. 41 and 42 show alternative intermediate frame members 43A. Intermediate frame member 43A includes downwardly extending flanges 226, and a solid panel 12A includes a clip 227 that engages a flange 226 to retain panel 12A. Intermediate frame member 43B includes a channel 228, and panel 12B includes a clip 229 that engages channel 228 to thereby retain panel 12B to intermediate member 43B. Intermediate frame members 43A and 43B may include screw bosses 145 that receive threaded fasteners to secure the intermediate frame members 43A and 43B to upright frame members 45 (FIG. 32). With further reference to FIG. 43, a corner post 235 includes side faces 236A, 236B, 236C and 236D. Side faces 236A and 236B include flanges 237 that are configured to engage adjacent flanges of one or more panels 10, 20, 30, and 40, whereby the corner post 235 can be secured to the adjacent panel utilizing resilient frame couplers 130 (e.g. FIG. 12). Side faces 236A and 236B also include channels 238 that are configured to receive (optionally) an alignment clip 137 and/or a post extension bracket 115 as described above in connection with FIG. 15. The corner post 235 can be utilized to form a corner joint 8A (FIG. 1). Post 235 may, optionally, include flanges 237 and channels 238 on one or more of side faces 236C and/or 236D to thereby form a T-post for a T junction 8B (FIG. 1) or an X junction having four adjacent panels joined at a single post 235. It will be understood that the post 235 may be configured to provide virtually any desired angle between adjacent panels that are attached to the post 235, and the side faces 236A-236D do not necessarily need to be orthogonal as shown in FIG. 43.

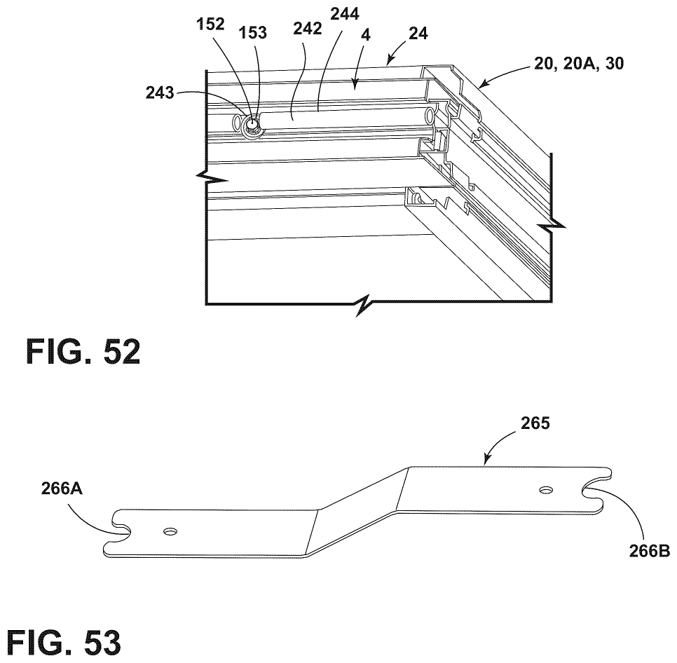

As discussed above, wall panels 20, 20A, and 30 may include one or more adjustment glides 150. The adjustment glides 150 are shown in more detail in FIGS. 44-52. With reference to FIGS. 44-46, glass frame members 20, 20A, and 30 may include a lower frame member 24 having a channel 160 that receives a lower edge of a sheet 22. With reference to FIG. 45, glide 150 includes a shaft 151 having a lower end 152 that extends through an opening 153 in floor track 4, and through an opening 243 in an elongated flexible seal 242 that is secured to floor channel 4 (see also FIG. 52). Seal 242 includes a tubular portion 244 that is deformed (flattened) when floor track 4 is positioned on a floor 2. Lower end 152 of shaft 151 directly contacts the floor 2.

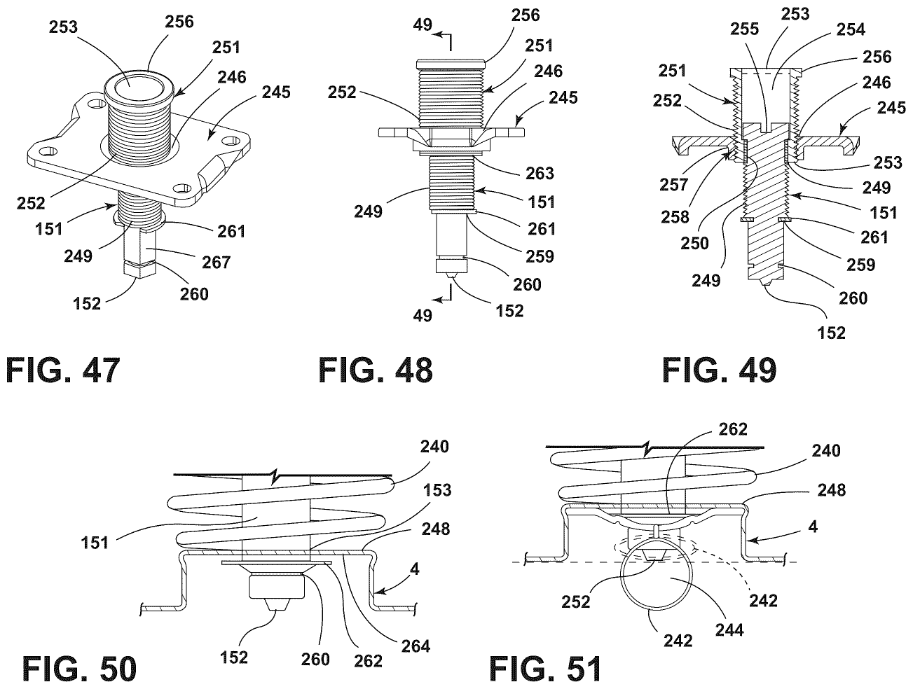

Glide 150 includes a bracket 245 that may be secured to a web or wall 247 of frame member 24. Glide 150 may also include a spring 240 that extends between raised center portion 248 of floor track 4 and frame member 24 such that the spring 240 biases the floor track 4 away from frame member 24. With further reference to FIGS. 47-49, shaft 151 may include external threads 249 that engage internal threads 250 (FIG. 49) of an upper glide member 251. Upper glide member 251 includes external threads 252 that threadably engage threaded opening 246 of bracket 245. As shown in FIG. 49, upper glide member 251 includes a generally cylindrical interior space 254 and an opening 253 whereby a tool (e.g. a screwdriver or hex wrench) may be inserted into cavity 255 to thereby rotate shaft 151 relative to upper glide member 251. Rotation of shaft 151 relative to upper glide member 251 causes axial movement of shaft 151 relative to upper glide member 251 due to the external threads 249 and internal threads 250 of shaft 151 and upper glide member 251, respectively. Rotation of upper glide member 251 relative to bracket 245 causes axial movement of upper glide member 251 relative to the bracket 245 due to the engagement of external threads 252 of upper glide member 251 with the internal threads of opening 246 in bracket 245. Upper glide member 251 may include an outwardly extending edge 256 that prevents upper glide member 251 from passing through threaded opening 246 in bracket 245. Similarly, shaft 151 includes an annular step surface 257 that engages a corresponding annular step surface 258 of upper glide member 251 to prevent movement of shaft 151 below the position shown in FIG. 49.

Shaft 151 includes a first annular groove 259 that receives an E-clip 261, and a second annular groove 260 that receives a retainer 260 (FIG. 50). The E-clip 261 limits the travel of shaft 151 relative to upper glide member 250 by contacting surface 263 of upper glide member 251 if shaft 151 is rotated relative to upper glide member 251 to a position in which shaft 151 is in its maximum raised position relative to upper glide member 251. Retainer 262 is secured to shaft 151 utilizing annular groove 260 after the lower end of shaft 151 is inserted through opening 153 (FIG. 50) of raised center portion 248 of floor track 4. As noted above, spring 240 biases lower frame member 24 away from floor track 4. However, the retainer 262 contacts lower surface 264 of raised center portion 248 of floor track 4 to thereby prevent shaft 151 from passing through opening 153 in raised portion 248 of floor track 4. Thus, the floor track 4 is retained to the wall panel 20, 20A, 30, etc.

In general, a floor track 4 used in connection with a glass wall panel 20, 20A, 30, etc. may have a length that is substantially equal to the lower horizontal frame member 24. Thus, during installation a ceiling track 5 may be secured to a ceiling 3 (e.g. FIG. 3), and the glass panel 20, 20A, 30 etc. may then be positioned below the ceiling track 5 without preinstalling the segment of floor track 4 connected to the glass panel 20, 20A, 30, etc. A wrench 265 having ratcheting open ends 266A and 266B that engage flat surfaces 267 (FIG. 47) of shaft 151 may be utilized to rotate the shaft 151 to thereby adjust a position of horizontal frame member 224 relative to the floor 2. In general, the shaft 151 may be rotated before, during, or after positioning of the glass panel in ceiling track 5.

Referring again to FIG. 51, rotation of shaft 151 will cause the vertical position of shaft 151 to change relative to upper glide member 251 if shaft 151 rotates relative to upper glide member 251. Similarly, rotation of upper glide member 251 relative to bracket 245 will shift the vertical position of upper glide member 251 and shaft 151 relative to bracket 245. In general, rotation of shaft 151 will cause vertical movement of shaft 151 relative to bracket 245 until the limits of travel of shaft 151 relative to upper glide member 251 and the limits of travel of upper glide member 251 relative to bracket 245 are reached. Because the upper glide member 251 moves relative to bracket 245, and shaft 151 moves relative to upper glide member 251, the total vertical adjustment capability of the glide 150 is greater than if, for example, the shaft 151 were to directly engage threaded opening 246 in bracket 245. Significantly, the glide 150 has a reduced overall height such that the lower horizontal frame member 24 (FIG. 44) can have a relatively small vertical dimension.

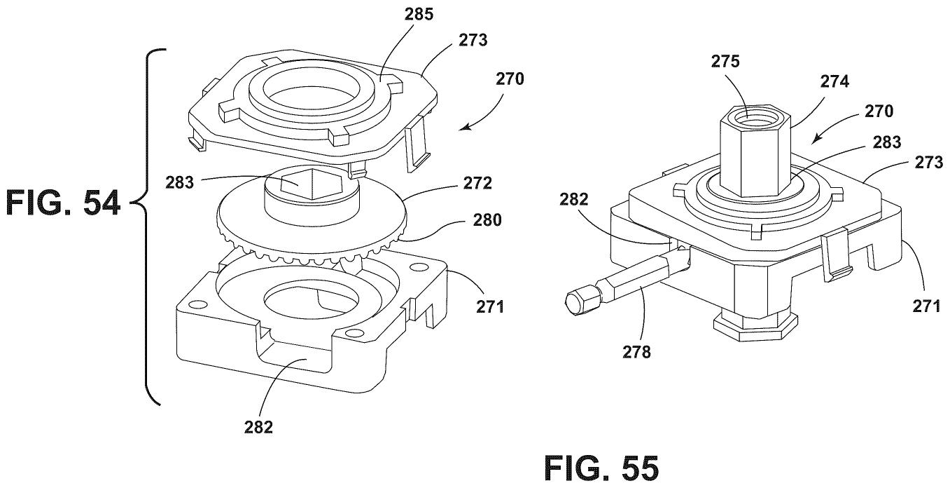

With further reference to FIGS. 54-57, a glide according to another aspect of the present disclosure includes a gear member 272 (FIG. 54) that has a hex opening 283 that, when assembled, receives a hex shaft 274 (FIG. 55). When assembled, upper member 273 of glide 270 is attached to base 271 to thereby rotatably retain gear 272 between base 271 and upper member 273. An opening 282 is configured to receive a Phillips head screwdriver bit 278 that engages teeth 280 (FIG. 54) of gear 272 such that rotation of bit 278 causes rotation of gear 272.

When assembled, a spring 284 engages an upper surface 285 of upper member 273, and a lower surface 286 of frame member 24 to thereby bias frame member 24 away from upper glide member 273. When assembled, base 271 is disposed in floor channel 4, and lower end 288 of hex shaft 274 extends through opening 287 in floor track 4. A lower end 281 of hex shaft 274 contacts floor surface 2. The internal threads 275 of hex shaft 274 engage external threads 276 of a rod 277 that may be fixedly secured to the lower frame member 24.

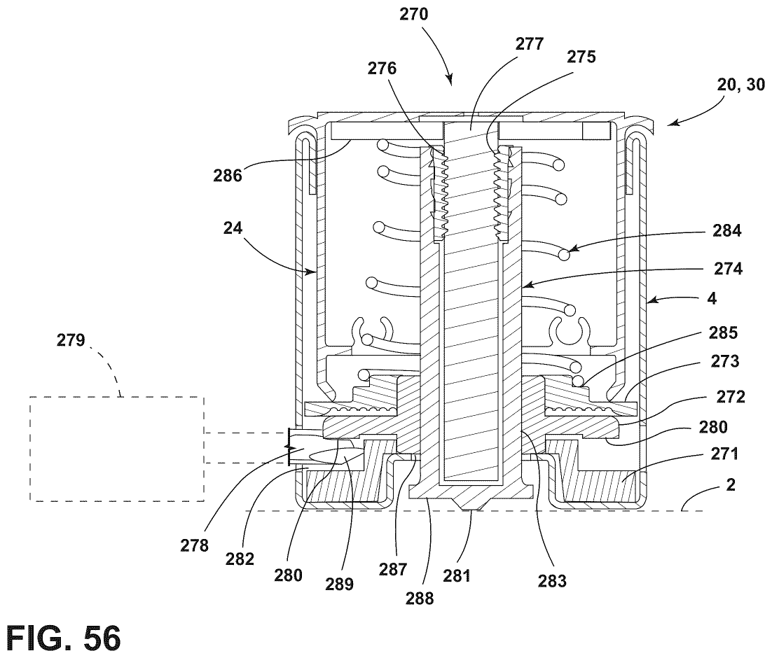

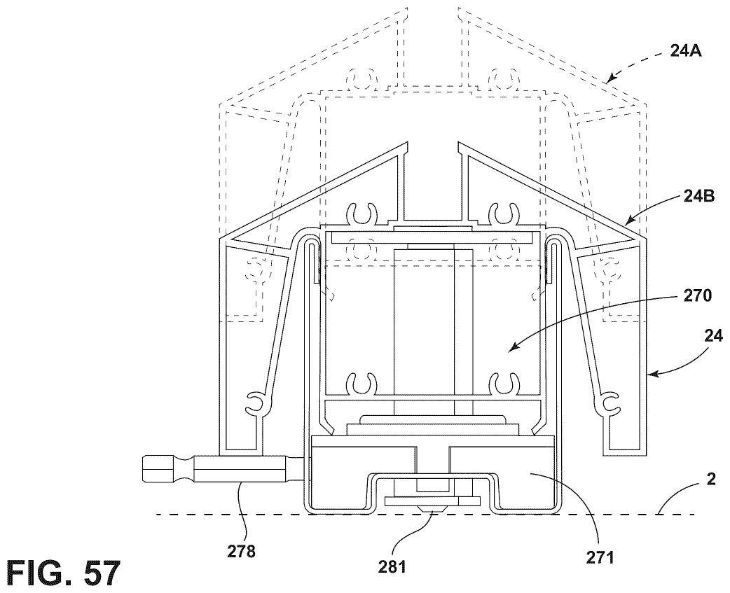

With reference to FIGS. 56 and 57, in use, bit 278 is inserted through opening 282 whereby the end 289 of bit 278 engages gears 280 of gear 272. An electric drill 278 or the like can then be actuated to rotate the bit 278 in a clockwise direction or a counterclockwise direction. Due to the engagement between hex shaft 274 and hex opening 283 in gear 272, rotation of gear 272 causes rotation of hex shaft 274, thereby rotating hex shaft 274 relative to rod 277. Due to engagement of threads 275 and 276, rotation of hex shaft 274 causes rod 277 and horizontal frame member 24 to shift vertically relative to hex shaft 274. Because lower end 281 of hex shaft 274 directly engages floor 2, rotation of hex shaft 274 therefore results in vertical translation of frame member 24 relative to floor 2. As shown in FIG. 57, frame member 24 can be shifted to an upper position 24A, a lower position 24B, or any position between the upper and lower positions 24A and 24B, respectively.

With further reference to FIG. 58, solid panels 12 may be attached to rigid panel frame 11 of a solid wall panel 10 by one or more latches 70 and one or more brackets 72. Latches 70 and brackets 72 may be secured to inner side or surface 290 of panel 12. Latches 70 may be secured to panel 12 adjacent vertical side edges 292 of panel 12, and adjacent upper side edge 293. Brackets 72 may be secured to panel 12 adjacent lower side edge 291 of panel 12. When panel 12 is in an installed position, the latches 70 engage posts 13 and upper horizontal frame member 14, and brackets 72 engage lower frame member 16.

As discussed above in connection with FIG. 12, each upright post 13 includes a pair of tubular outer portions 123 having inner surfaces 319 that face one another (see also FIG. 64). The upright posts 13 further include a base surface 320 that extends between the surfaces 319 of the tubular outer portions 120. The surfaces 319 and 320 form a vertically extending channel 318 on the inner sides 18 of vertical posts 13 (see also FIG. 64).

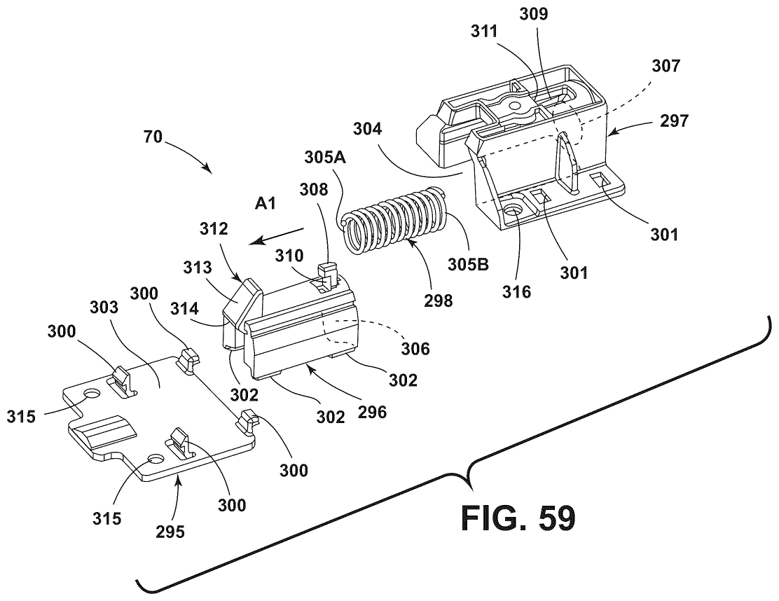

With reference to FIG. 59, each latch 70 includes a base 295, a slide or movable retainer 296, a spring 298, and a housing 297. Base 295 may include a plurality of barbed prongs 300 that are configured to engage openings 301 of housing 297 when latch 70 is assembled. When assembled, pads 302 of movable retainer 296 slidably engage surface 303 of base 295, and the movable retainer 296 is slidably disposed in a cavity formed by base 295 and recess 304 of housing 297. When assembled, a first end 305A of spring 298 bears against end 306 of movable retainer 296, and a second end 305B of spring 298 bears against an inner surface 307 of housing 297 to thereby bias the movable retainer 296 in the direction of the arrow “A1” towards an engaged or latched position. When latch 70 is assembled, extension 308 of movable retainer 296 is received in slot 309 of housing 297, and surface 310 of extension 308 contacts surface 311 of housing 297 adjacent an end of slot 309 due to the bias of spring 298. This contact between surfaces 310 and 311 limits the travel of movable retainer 296 in the direction of the arrow A1.

The movable retainer 296 further includes a latch structure 312 which may be in the form of a protrusion having an angled surface 313 and a retaining surface 314. The angled surface 313 and the retaining surface 314 may be on generally opposite sides of the latch structure 312. The latches 70 may be secured to inner side or surface 290 of panel 12 adjacent a side edge 292 or 293 utilizing screws or the like 317 (FIG. 60) that extend through clearance openings 315 in base 295 and/or openings 316 in housing 297 (FIG. 59).

With reference to FIGS. 60 and 61, when panel 12 is in an installed position on rigid panel frame 11 the latches 70 mounted to panel 12 adjacent the vertical edges 299 of panel 12 engage vertical channels 318 in posts 13. Specifically, when panel 12 is in an installed position on rigid frame 11, the movable retainer 296 is disposed in a latched position due to the bias of spring 298. When the movable retainer 296 is in the latched position shown in FIGS. 60 and 61, the retaining surface 314 of latch structure 312 of movable retainer 296 engages surface 319 of post 13, such that the panel 12 cannot be moved away from post 13. However, movable retainer 296 can be manually moved away from the latched position of FIGS. 60 and 61 by applying a force sufficient to overcome the bias of spring 298, whereby the retaining surface 314 no longer engages surface 319 of post 13, thereby permitting movement of panel 12 away from rigid frame 11.

Upper frame member 14 of rigid panel frame 11 includes a channel 19 that opens downwardly (See also FIG. 2). Channel 19 of upper frame member 14 (and channel 48 of frame member 43) has a size and a shape that are substantially similar to the vertical channel 318 of post 13. Thus, the latches 70 positioned adjacent upper edge 293 of panel 12 engage channels 19 and 318 in substantially the same manner. Similarly, latches 70 of clerestory wall panel 40 engage surfaces 44 (FIG. 36) of frame member 43 to retain panel 12 to frame member 43.

With further reference to FIG. 62, brackets 72 may be secured to inner side 290 of panel 12 utilizing fasteners such as screws 325. Lower frame member 16 includes spaced apart upwardly protruding portions 326 forming a horizontally extending upwardly opening U-shaped channel 111, which is generally bounded by surfaces 112 of upwardly protruding portions 326 and an upwardly facing base surface 112A of lower horizontal member 16.

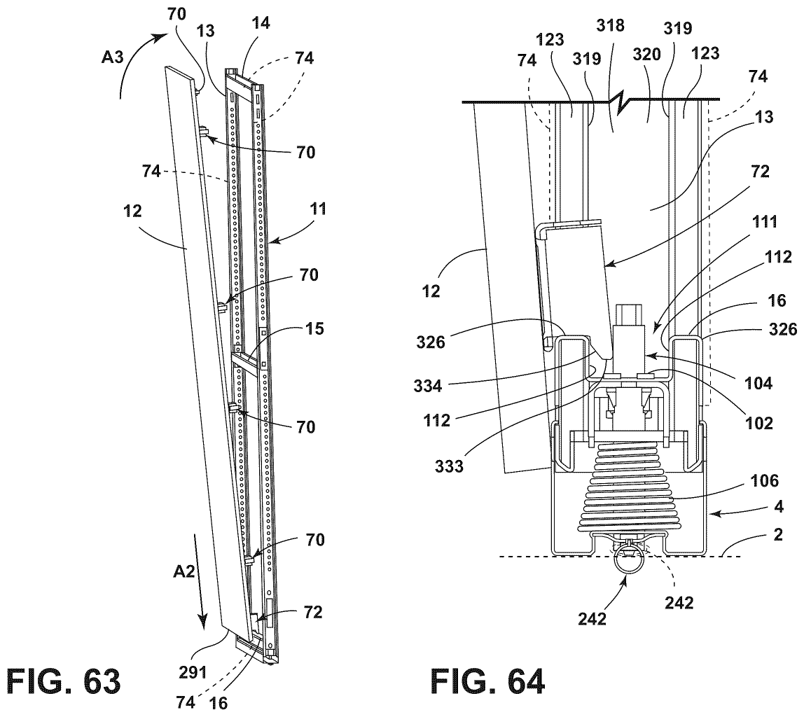

Referring again to FIG. 62, bracket 72 may be formed from sheet metal or the like, and may include a hat-shaped central portion 327 including flanges 328, sidewalls 329, and 330. When panel 12 is in an installed position, lower edges 331 of sidewalls 329 abut an upper surface 332 of upwardly protruding portion 326 of lower frame member 16 to vertically support panel 12 on horizontal frame member 16. Bracket 72 includes a downwardly extending protrusion 333 that is received in channel 111 to thereby prevent outward movement of panel 12 away from rigid frame 11. The downwardly extending protrusion 333 may have a tapered or angled surface 334 that engages surfaces 112 and/or 332 of upwardly protruding portions 326 of horizontal frame member 16 during installation of panel 12 as discussed below in connection with FIGS. 63 and 64. The protrusion 333 may be formed from sheet metal as shown in FIG. 62, or the protrusions 333 may be formed as shown in FIG. 64.

Referring again to FIG. 62, bracket 72 may include horizontal upper tabs or flaps 336 having angled edges 337. As shown in FIG. 58, a bracket 72 may be positioned at each lower corner 338 of panel 12. As panel 12 is installed (FIGS. 63 and 64), if the panel 12 is not initially centered on rigid frame 11, the angled surface 337 of bracket 72 may slidably engage post 13 to thereby horizontally shift panel 12 to a centered position as the panel 12 is rotated to the installed position. Bracket 72 preferably includes tapered or angled surfaces 337 on opposite sides of bracket 72 such that bracket 72 can be used at either lower corner 338 of panel 12.

As discussed above, resilient strips 74 (FIG. 62) may be secured to opposite side surfaces of rigid frame 11. The resilient strips 74 bias the panel 12 away from the rigid panel frame 11, such that tapered surfaces 334 of bracket 72 are biased into engagement with surfaces 112 of frame 11, and retaining surfaces 314 (FIGS. 59-61) of latches 70 are biased into engagement with surfaces 319 of rigid frame 11.

With further reference to FIGS. 63 and 64, during installing of panel 12 to rigid frame 11, the downwardly extending protrusions 333 of brackets 72 are initially positioned in channel 111 of lower frame member 112 by shifting the panel 12 downwardly in the direction of the arrow “A2.” It will be understood that brackets 72 are preferably configured as shown in FIG. 62, but may have alternative configurations as shown in FIG. 64. The panel 12 is then rotated inwardly towards the rigid panel frame 11 as shown by the arrow “A3.” As panel 12 is rotated towards the rigid frame 11, angled surface 313 of the movable retainers 296 engage the post 13 and upper frame member 14, thereby causing the movable retainers 296 to shift away from the latched position and further compressing spring 298. When the panels 12 reach the fully installed position (FIGS. 60 and 61), the bias from spring 298 causes the movable retainers 296 to shift to the latched position shown in FIGS. 60 and 61 to retain the panel 12 on the rigid panel frame 11.

Also, if the panel 12 is not initially centered on frame 11, angled edges 337 (FIG. 62) of brackets 72 may engage surfaces of one or both posts 13 to thereby cause the panel 12 to shift to a centered position on rigid frame 11 as panel 12 is rotated to an upright installed position.

When the panel 12 is fully installed, the movable retainers 296 shift outwardly to latched positions due to bias of springs 298, and retaining surfaces 314 of movable retainers 296 engage post 13 and frame member 14 to thereby retain the panel 12 on the rigid panel frame 3. As noted above, a force can be applied to the movable retainers 296 to shift the movable retainers to a released position (i.e. opposite the direction of the arrow A1, FIG. 59) to disengage the latches 70 and permit removal of panel 12 from rigid frame 11.

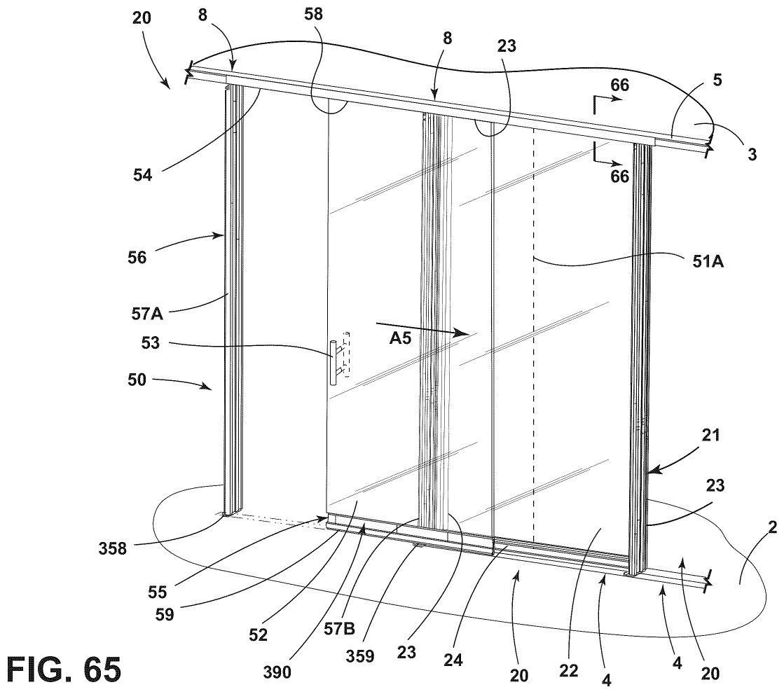

With further reference to FIG. 65, sliding door assembly 50 includes a sliding door 51 having a sheet of glass 52 and a handle 53 attached to the glass sheet 52. As discussed in more detail below, the door 51 is supported by an overhead door track 54 whereby the door 51 can be shifted horizontally as shown by the arrow “A5” to an open position in which the door 51 overlaps an adjacent glass wall panel 20 to permit access through door opening 55. The sliding door assembly 50 includes a stationary door frame 56 comprising uprights 57A and 57B that are rigidly interconnected with a header 58. As discussed in more detail below, the stationary door frame 56 engages ceiling track 5. The adjacent glass wall panel 20 may engage the ceiling track 5, and glass wall panel 20 may include a floor track 4 in substantially the same manner as described above in connection with FIG. 16. It will be understood that the floor track 4 does not extend across the door opening 55.

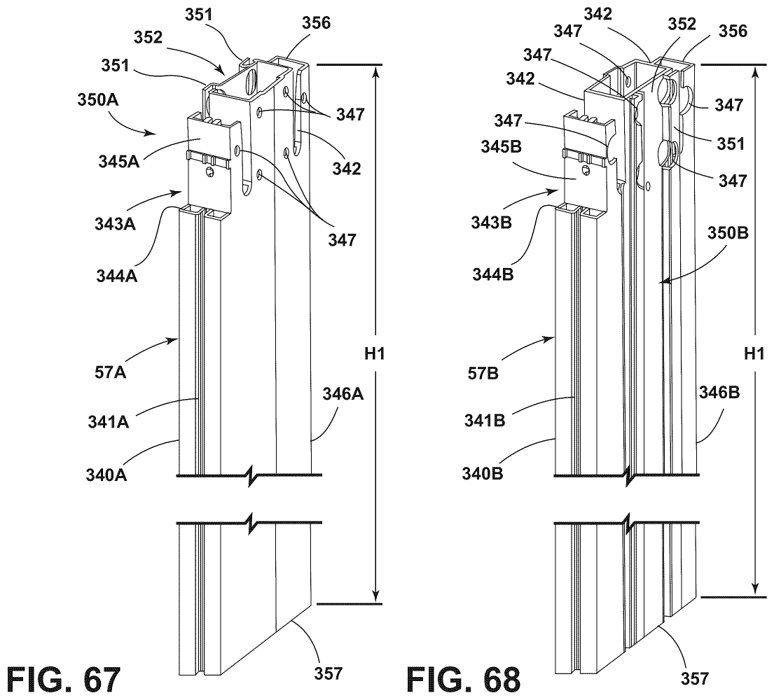

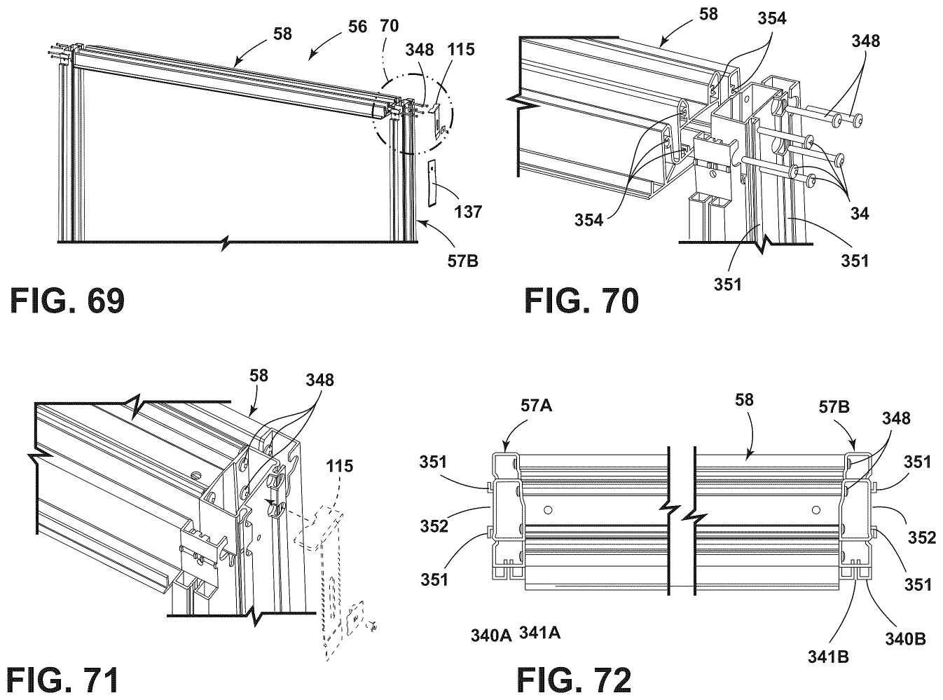

With further reference to FIGS. 67 and 68, upright door frame members 57A and 57B may comprise generally tubular members having front portions 340A and 340B having grooves 341A and 341B, respectively. As discussed below, the grooves 341A and 341B are configured to receive a vertical seal strip. The upper ends of upright door frame members 57A and 57B include cutouts 342 that provide clearance for sidewalls 6 of ceiling track 5 (FIG. 66). The upright door frame members 57A and 57B also include cutout portions 343A and 343B at which the front tubular portions 340A and 340B are cut away to form edges 344A and 344B and to expose surfaces 345A and 345B, respectively. The rear portions 346A and 346B of door frame members 57A and 57B do not include cutouts 343A, 343B, such that the front portions 340A and B are not identical to rear portions 346A and B, respectively. The stationary door frame members 57A and 57B also include a plurality of clearance openings 347. As discussed below in connection with FIGS. 69-71, the clearance openings 347 are configured to receive threaded fasteners 348 to secure the door frame members 57A and 57B to the overhead frame member 58. The vertical outer sides 350A and 350B of upright frame members 57A and 57B, respectively, include flanges 351 and a vertically extending channel 352 between the flanges 351 (see also FIG. 72). The flanges 351 are configured to abut adjacent flanges of any one of panels 10, 20, 30, and 40 whereby the upright frame members 57A and 57B can be interconnected with an adjacent wall panel utilizing resilient frame couplers 130.

With reference to FIGS. 69-72, during assembly of stationary door frame 56, threaded fasteners 348 are inserted through clearance openings 347 and into screw bosses 354 of overhead frame member 58. An alignment clip 137 may be secured to at least one of the uprights 57A or 57B by positioning the alignment clip 137 in a vertical channel 352. Post extensions 115 may also be secured to the stationary door frame 56 at the upper ends of upright door frame members 57A and 57B.

Optionally, prior to assembly of upright door frame members 57A and 57B to overhead frame member 58 (FIGS. 69-71), upright frame members 57A and 57B may be cut to length if required. More specifically, referring to FIG. 66, a height “H1” from an upper edge 355 of adjacent glass wall panel 20 to the floor 2 may be measured, and the lower ends of upright frame members 57A and 57B may be cut such that a distance between upper edge 356 and lower edge 357 of upright frame members 357A and 357B (FIGS. 67 and 68) is also H1.

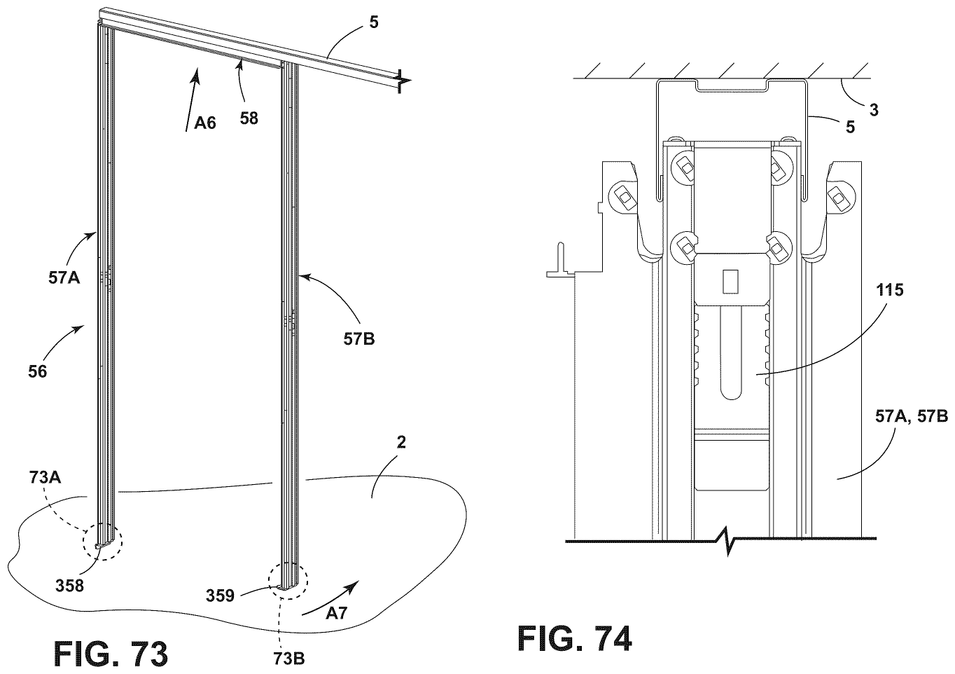

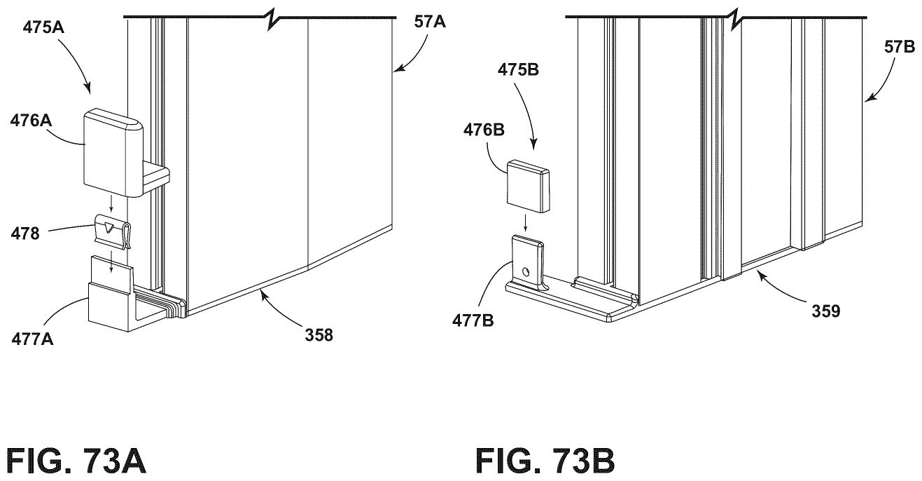

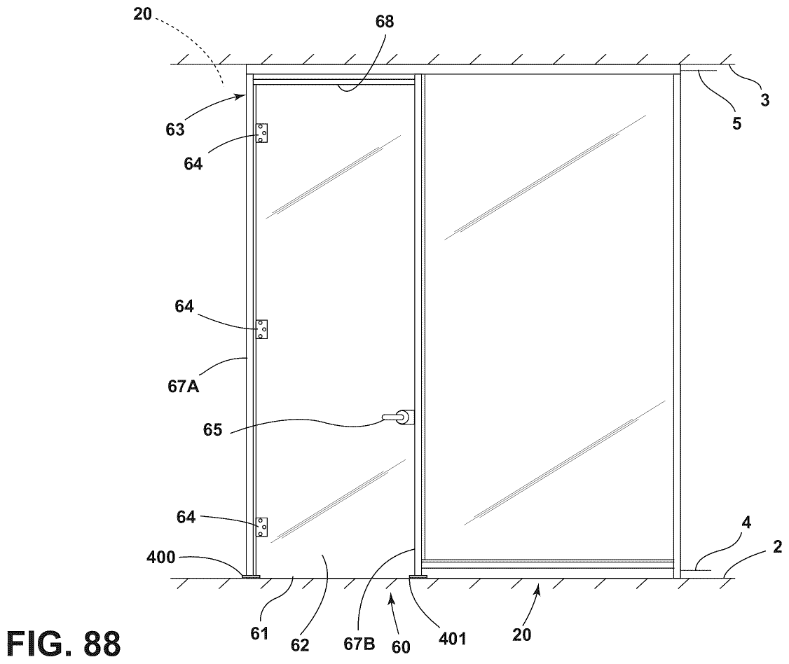

With further to FIG. 73, the stationary door frame 56 may then be moved to an installed position by shifting header 58 upwardly into engagement with channel 5 as shown by the arrow “A6,” and the door frame 56 may then be rotated to a vertical position as shown by the arrow “A7.” Floor brackets 358 and 359 may then be secured to the floor 2. Optionally, the position of the floor brackets may be determined in substantially the same manner described in more detail below in connection with the swing door (FIGS. 88-95).

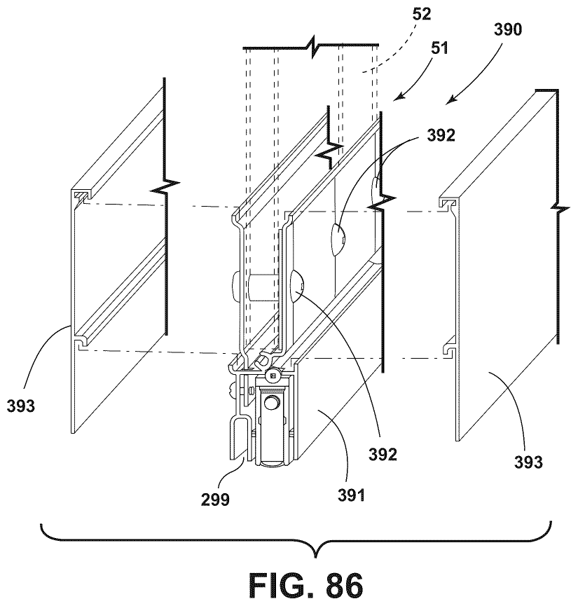

With reference to FIGS. 73A and 73B, leading edge floor bracket 358 may, optionally, include a guide 475A, and trailing edge floor bracket 359 may, optionally, include a guide 475B. Guide 475A includes a guide cap 476A that when assembled, is retained on an upwardly extending portion 477A of bracket 358 by a clip 478. Guide 475B includes a guide cap 476B that, when assembled, is positioned on upwardly extending portion 477B of bracket 359. Guides 475A and 475B are received in channel 299 of channel bracket assembly 391 (FIGS. 85 and 86) to guide door 51 as door 51 moves between the open and closed positions. In particular, the guides 475A and 475B may limit or prevent motion of lower portion 59 of door 51 in directions transverse to the opening/closing direction A5 (FIG. 65).

After the stationary door frame 56 is positioned adjacent to wall panel 20, the stationary door frame 56 may be connected to adjacent wall panel 20 utilizing resilient frame couplers 130 and flanges 351 to form a vertical joint 8 in substantially the same manner as shown above in FIGS. 12 and 22.

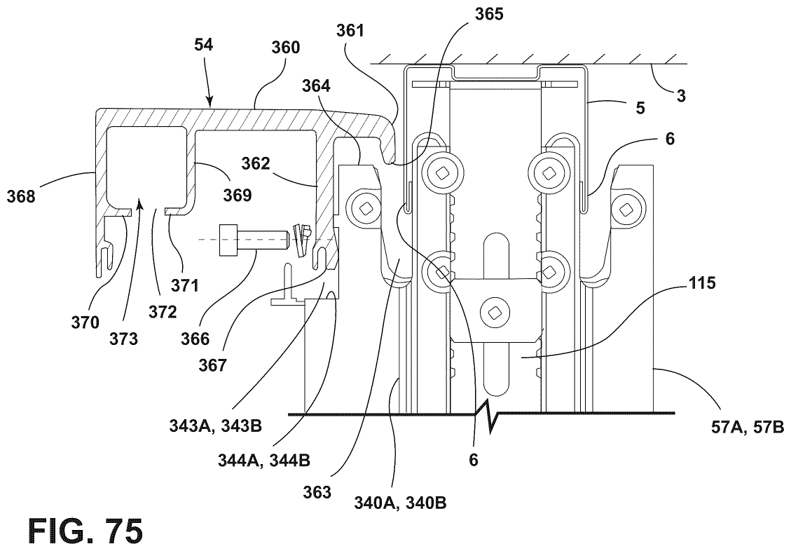

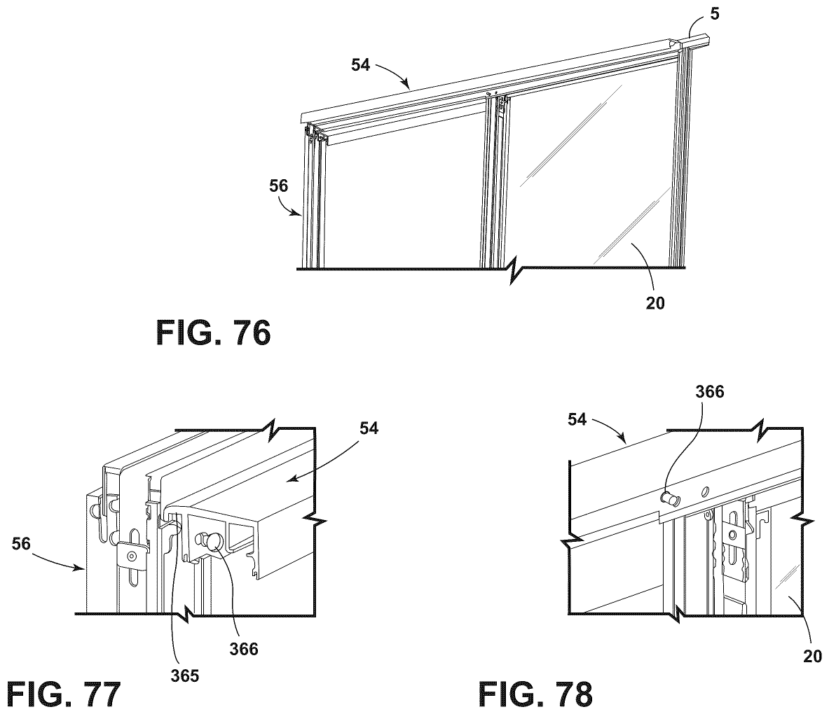

With further reference to FIGS. 75-78, overhead door track 54 may then be secured to stationary door frame 56 and to adjacent wall panel 20 such that the overhead track extends across the stationary door frame 56 and the adjacent wall panel 20 as shown in FIG. 76. With reference to FIG. 75, the overhead door track 54 includes an upper wall 360, a downwardly extending lip 361 and a downwardly extending wall 362, that together form a downwardly opening hook 365. The door frame 56 and glass panel 20 each include a cutout portion 363 and an upwardly extending portion 364. During assembly, the hook 365 of door track 54 is shifted into engagement with cutout 363 and upwardly extending portion 364, and a plurality of threaded fasteners are utilized to secure the overhead track to the door frame 56 and glass wall panel 20. The lower end 367 of wall 362 of door track 54 is disposed in cutouts 343A and 343B of upright door frame members 57A and 57B, respectively adjacent to the front portions 340A and 340B of upright door frame members 57A and 57B, respectively, and the lower end 367 may abut edges 344A and 344B of upright door frame members 57A and 57B, respectively (see also FIGS. 67 and 68). Thus, the door track 54 can only be installed on one side of the stationary door frame 56.

Referring again to FIG. 75, the overhead door track 54 further includes downwardly extending walls 368 and 369 having horizontal end portions 370 and 371 that are spaced apart to form a gap 372 to form a roller support track 373.

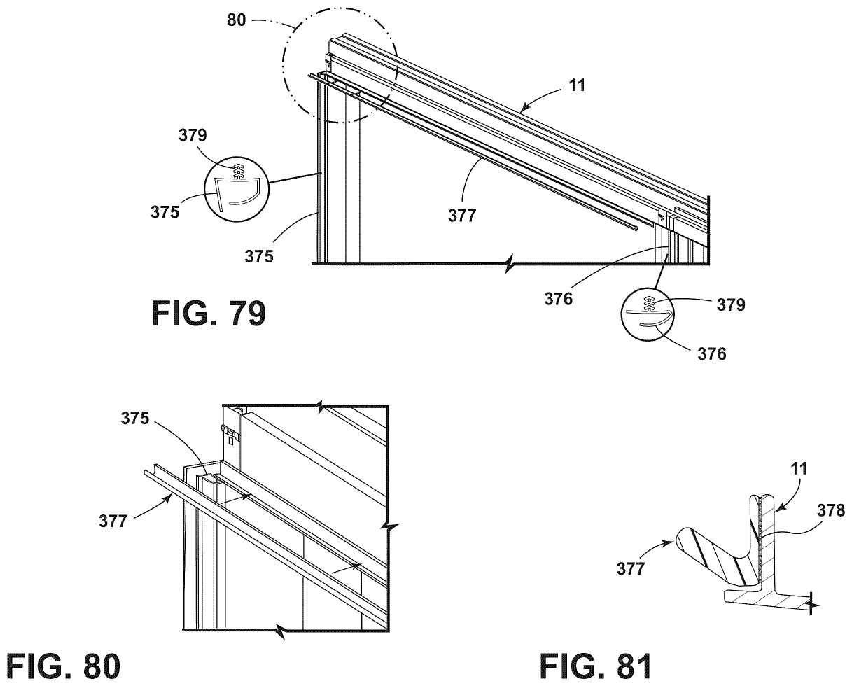

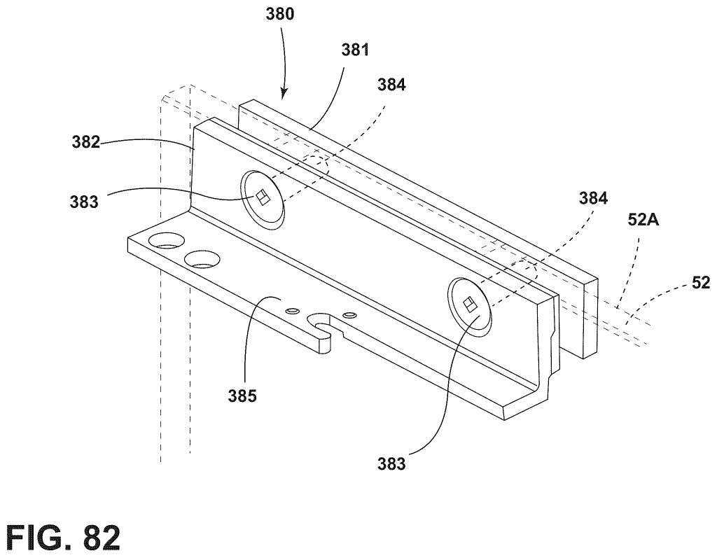

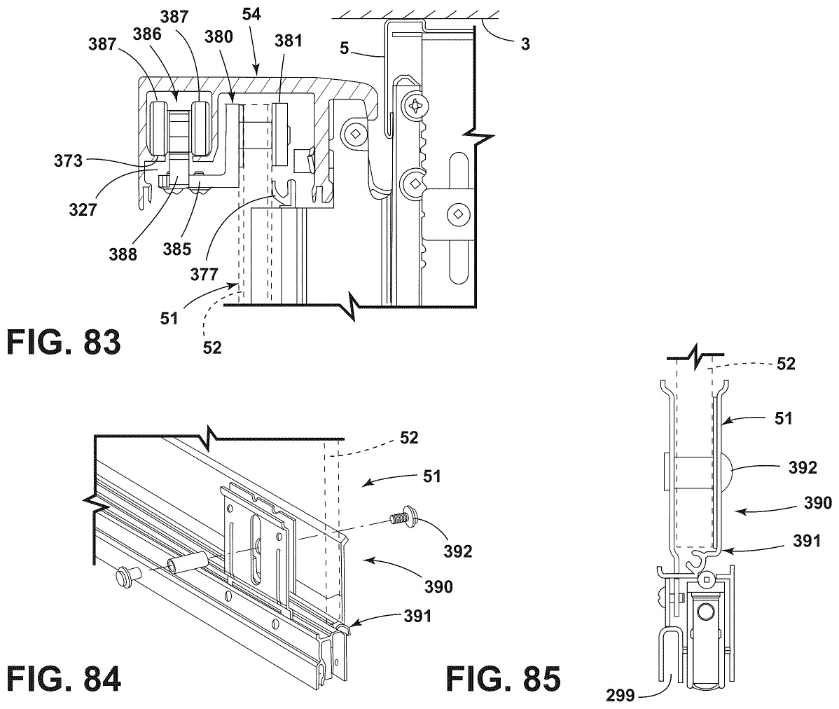

With further reference to FIGS. 79-81, resilient vertical seal strips 375 and 376 may be inserted in grooves 341 and 341B of upright frame members 57A and 57B, respectively, and an upper acoustic seal 37 may be adhesively secured to the door frame 11 utilizing adhesive 378 (FIG. 84). The vertical seals 375 and 376 may include barbed connectors 379 that are received in grooves 341A and 341B of upright door frame members 57A and 57B, respectively. With further reference to FIGS. 82 and 83, roller brackets 380 may be secured to an upper edge portion 52A of glass 52. Bracket 380 includes first and second portions 381 and 382, respectively that are secured to a sheet 52 utilizing threaded fasteners 383 that extend through openings 384 in sheet 52. Second bracket portion 382 includes a horizontally extending flange 385 to which a roller assembly 386 (FIG. 83) is mounted to thereby position rollers 387 in roller support track 373. Roller assembly 386 includes rollers 387 and an upwardly extending portion 388 that extends through gap 372. Door assembly 50 may include a closing mechanism (e.g. a soft closing mechanism) of a known type (not shown) that operably interconnects the door 51 with the stationary door frame 56 and/or adjacent panel 20 to thereby control horizontal opening and closing movement of the door.

With further reference to FIGS. 84-86, an acoustic drop seal assembly may be secured to a lower portion of the sheet 52 of door 51. Specifically, a channel bracket assembly 391 is secured to sheet 52 utilizing threaded fasteners 392 (FIGS. 84 and 85), and covers 393 are then secured to the channel bracket assembly 391.

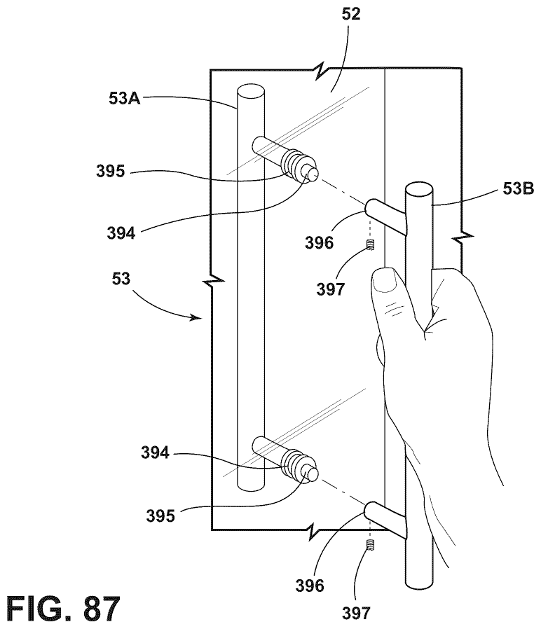

With further reference to FIG. 87, door handle 53 may then be installed by positioning ends 394 of a first handle part 53A in openings 395 in sheet 52. Open ends 396 of a second handle part 53B are then engaged with ends 394 of first handle part 53A. Set screws 397 may then be tightened to engage ends 394 to thereby rigidly interconnect first and second handle parts 53A and 53B on opposite sides of sheet 52.

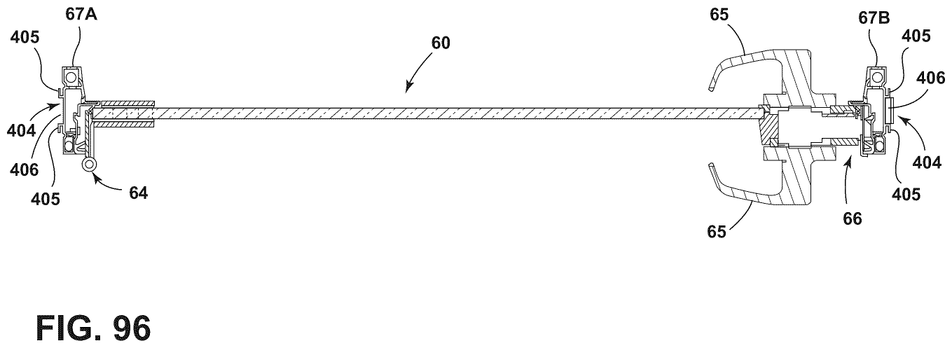

With further reference to FIG. 88, pivoting door assembly 60 may include a sheet 62 that is pivotably or rotatably mounted to a door frame 63 by hinges 64. The door is releasably retained in a closed position by a striker 66. The pivoting door assembly 60 may be mounted adjacent to one or more wall panels such as glass wall panels 20. The door frame 63 of pivoting door assembly 60 includes upright frame members 67 that are rigidly interconnected to an overhead frame member 68. Door handles 65 may be utilized to latch and unlatch the door 61 from striker 66. As discussed in more detail below, the lower ends of upright door frame members 67 may be secured to the floor 2 utilizing floor brackets 400 and 401. As discussed in more detail below in connection with FIGS. 96-110, the vertical positions of hinges 64 and striker 66 on upright door frame members 67 may be adjusted during assembly.

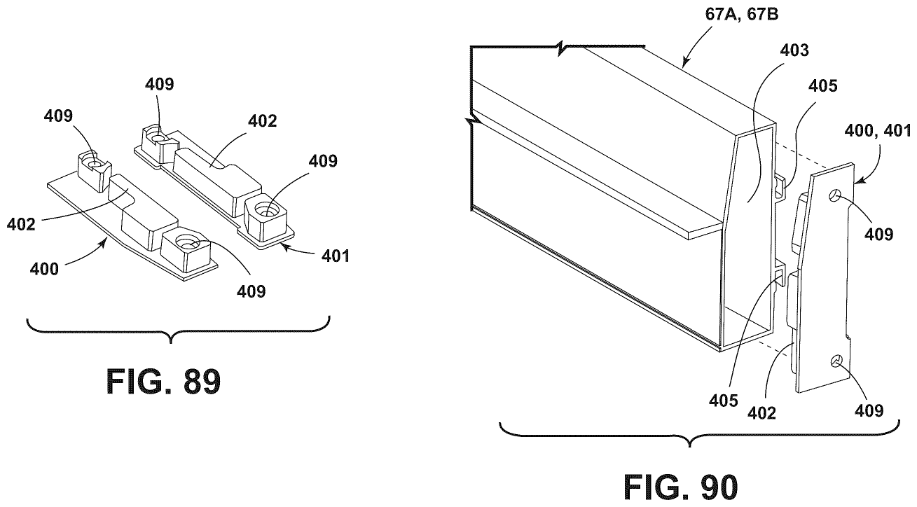

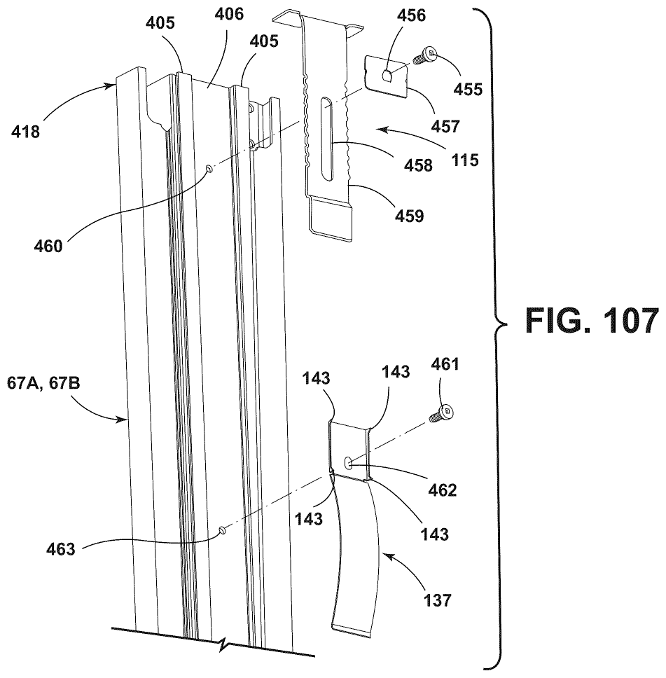

With further reference to FIGS. 89 and 90, floor brackets 400 and 401 include retaining structure 402 that is configured to be received in open lower ends 403 of uprights 67A and 67B. The outer sides 404 of uprights 67A and 67B may include flanges 405, and a vertically extending channel 406 whereby the door frame 63 can be interconnected to adjacent wall panels utilizing resilient frame couplers 130 and alignment clips 137 as described above. Furthermore, the door frame 63 may be positioned in ceiling channel 5 utilizing post extension brackets 115 in substantially the same manner as described in more detail above (see also FIG. 107).

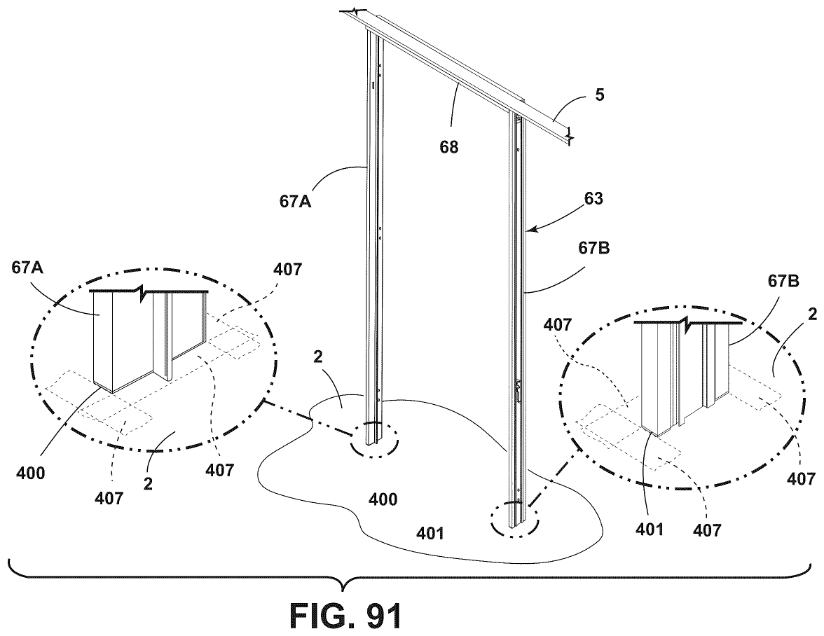

With further reference to FIG. 91, the overhead frame member 68 may be secured to upright frame members 67A and 67B utilizing threaded fasteners or the like, and the overhead frame member 68 can be positioned in ceiling channel 5 with the frame members 67A and 67B in an upright position with the floor brackets 400 and 401 positioned on the floor 2. As discussed in more detail below in connection with FIGS. 96-110, the uprights 67A and 67B may be cut to length if necessary prior to positioning the floor brackets 400 and 401 in the ends 403 of the upright frame members 67A and 67B. The floor brackets 400 and 401 may be temporarily secured to the lower ends 403 of uprights 67A and 67B prior to positioning the frame 63 in ceiling track 5. The door frame 3 is shifted to its final position with uprights 67A and 67B in a vertical position, and the positions of floor brackets 400 and 401 are then marked on the floor utilizing temporary markings such as masking tape 407.

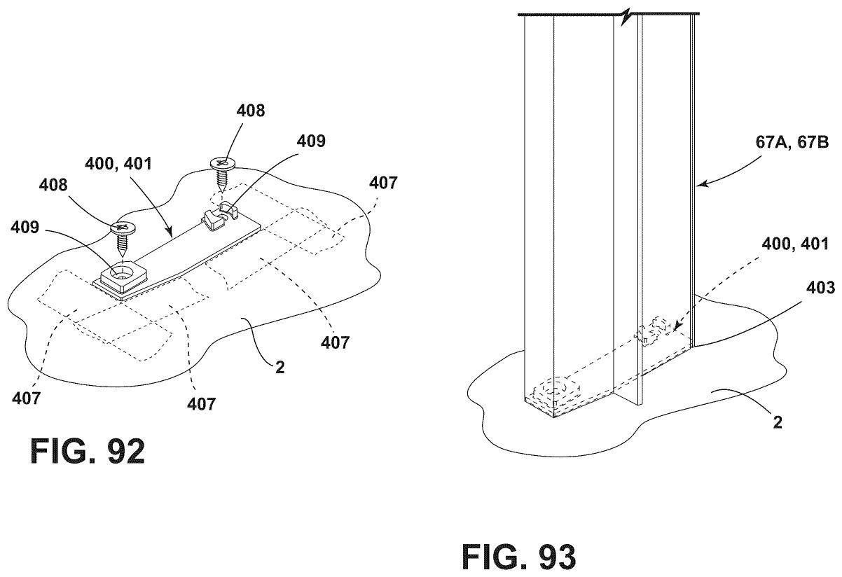

With further reference to FIG. 92, door frame 63 is then removed from engagement with ceiling track 5, and the floor brackets 400 and 401 are then removed from the ends 403 of the uprights 67A and 67B. The floor brackets 400 and 401 are then positioned on the floor 2 in the proper locations utilizing tape 407. Brackets 400 and 401 may then be secured to the floor 2 utilizing threaded fasteners 408 that are driven through openings 409 and floor brackets 400 and 401. Alternatively, the floor brackets 400 and 401 more may be secured to the floor utilizing double sided tape, adhesive or other suitable fastening arrangement. The door frame 63 can then be positioned again in ceiling track 5 in substantially the same manner discussed above in connection with FIG. 91, and the frame 63 can be shifted downwardly, such that the floor brackets 400 and 401 are received in the lower ends 403 of the upright frame members 67A and 67B. Because the protrusions 402 (FIG. 89) of brackets 400 and 401 are closely received within the open ends 403 of uprights 67A and 67B, the floor brackets 400 and 401 securely retain the upright frame members 67A and 67B in the correct locations.

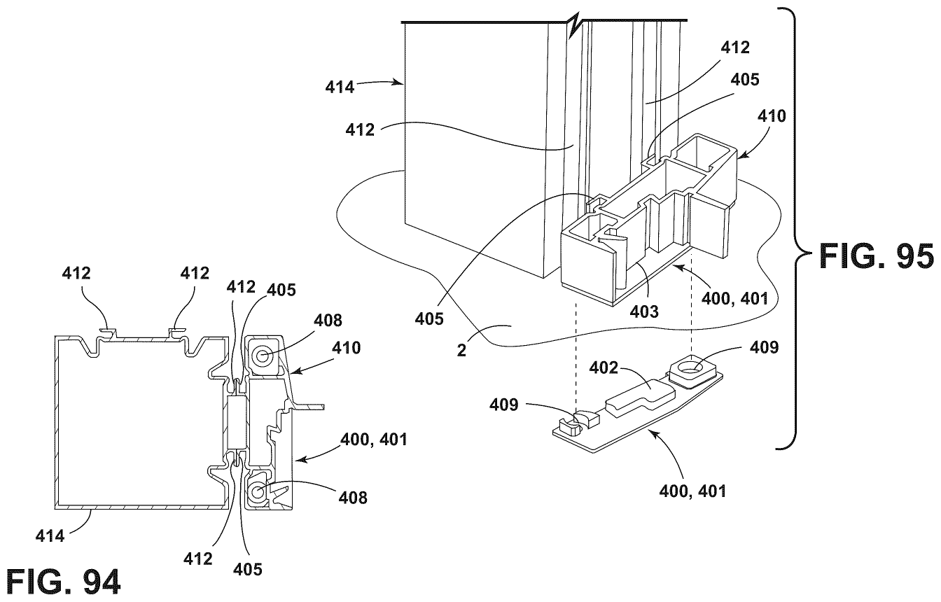

An alternative method of positioning floor brackets 400 and 401 is shown in FIGS. 94 and 95. First, an end piece 410 is cut from uprights 67A and 67B. In the illustrated example, the end piece 410 is a piece of upright 67A. However, a corresponding end piece 410 is also cut from upright 67B. The floor bracket 400 or 401 is then positioned in the open lower end 403 of the end piece 410, and the end piece 410 is positioned directly adjacent a post 414 of an adjacent wall panel with flanges 405 of end piece 410 in contact with flanges 412 of post 414. The floor bracket 400 or 401 is then secured to the floor 2 utilizing threaded fasteners 408 that are driven into the floor through openings 409 in bracket 400 or 401. Alternatively, the floor brackets 400 and 401 may be secured to the floor 2 utilizing adhesive, double sided tape, or other suitable fastening arrangement.

The end piece 410 is then removed, leaving the floor brackets 400 and 401 on the floor in their proper position. The door frame 63 is then positioned in substantially the same manner shown above in FIG. 91, and the lower ends of uprights 67A and 67B are positioned on floor brackets 400 and 401.

With reference to FIG. 96, during installation, the handedness of the door uprights 67A and 67B is determined. In general, the uprights 67A and 67B are mirror image opposites of each other, and the verticals are selected to correctly orient the hinges 64 and striker 66 to the required door orientation needed per plan view (FIG. 96).

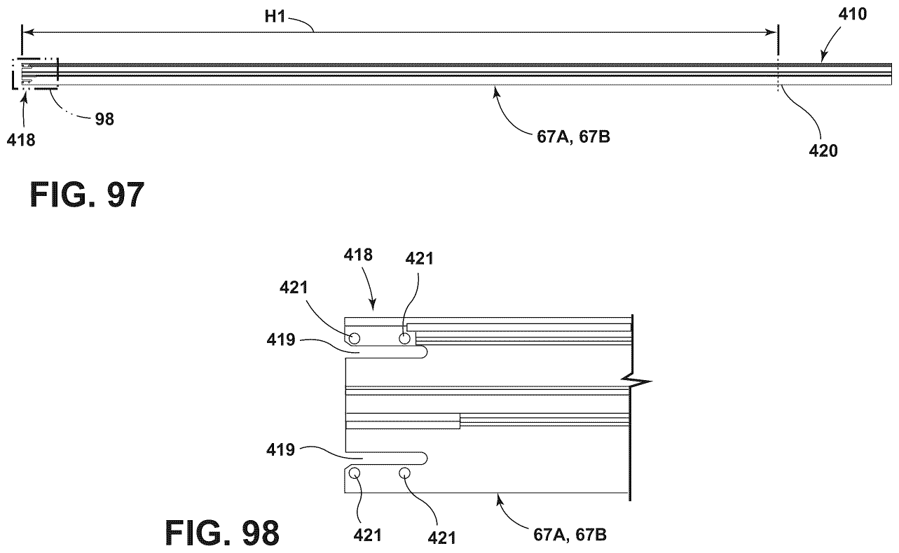

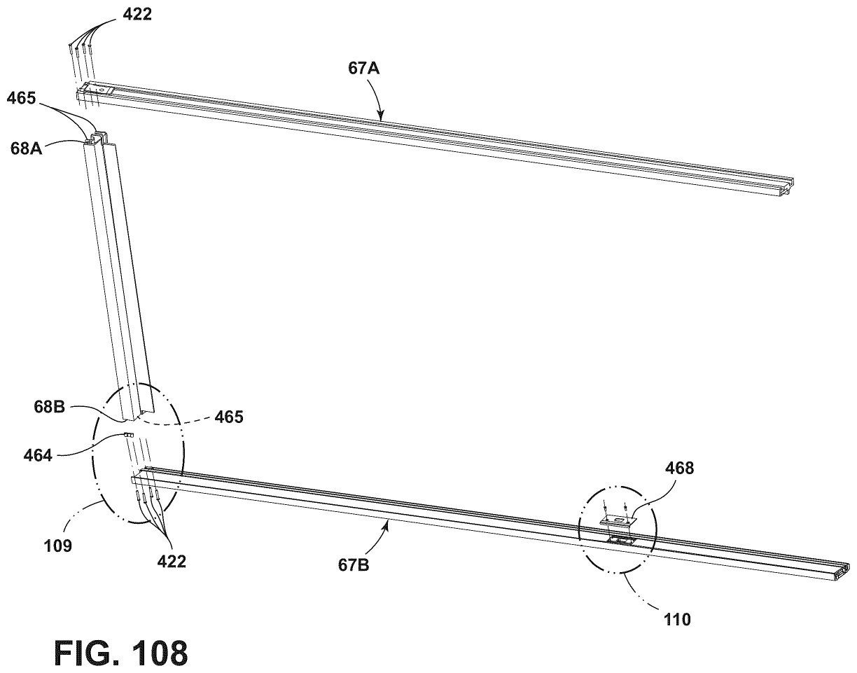

With reference to FIGS. 97 and 98, the uprights 67A and 68B are cut at a cutline 420 at a distance “H1” from the upper ends 418 of uprights 67A and 67B. The distance H1 may be determined by measuring the door opening (FIG. 88). The distance H1 may be somewhat less than the total length required to account for the floor brackets 400 and 401. Ends 418 of uprights 67A and 67B include cutouts 419 to provide clearance for ceiling track 5. Clearance openings 421 provide clearance for threaded fasteners 422 (FIG. 108) during assembly of the door frame 63.

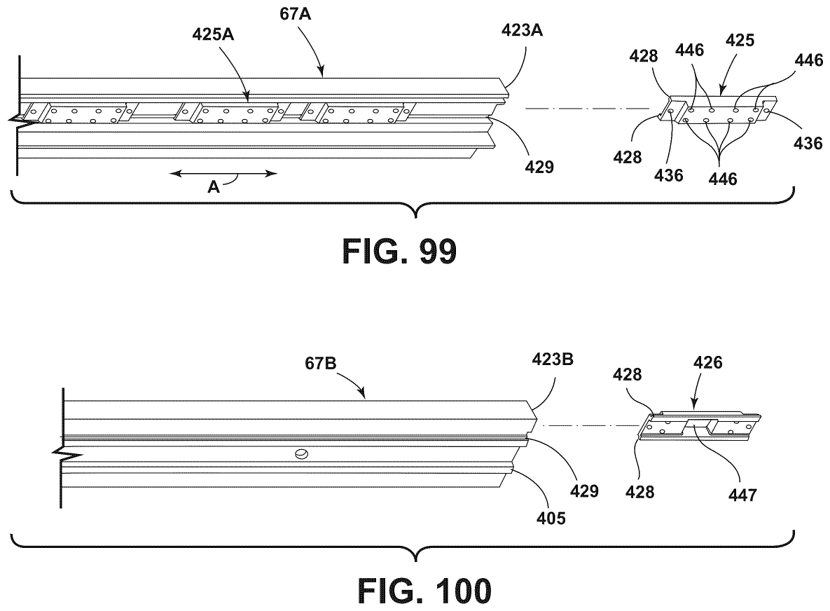

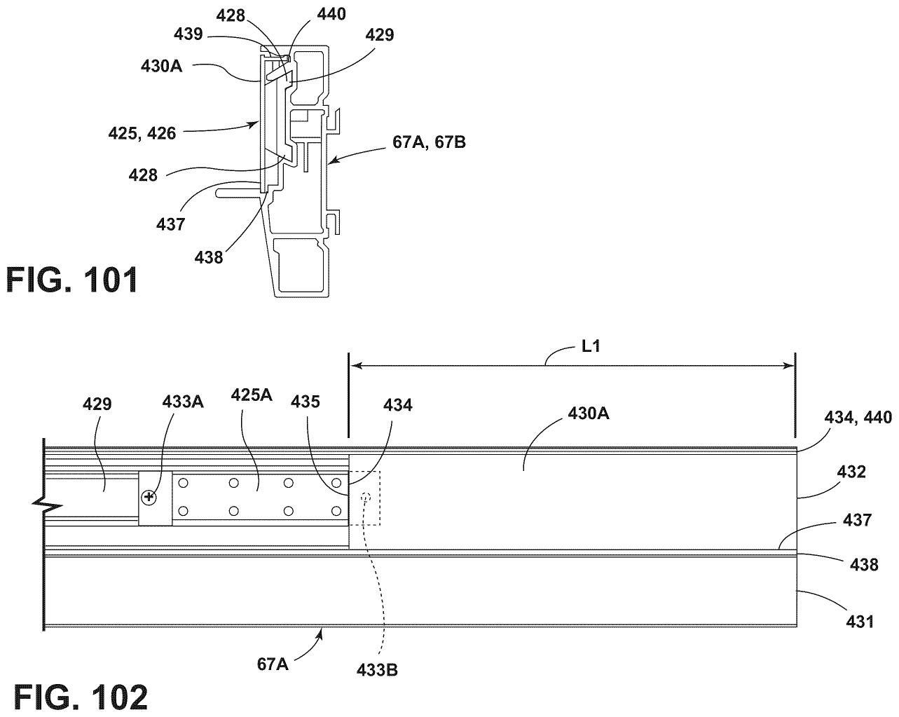

With further reference to FIGS. 99 and 100, hinge trucks 425 and strike trucks 426 are installed to uprights 67A and 67B, respectively, by sliding them up from the bottoms 423A and 423B, respectively of the uprights 67A and 67B, respectively. The hinge truck 425 and strike truck 426 include dovetail projections 428 that are slidably received in corresponding channels 429 of uprights 67A and 67B. Hinge truck 425 includes a plurality of openings 446 (FIG. 99) that are configured to receive threaded fasteners to secure hinges 64 to strike truck 426, and strike truck 426 includes an opening 447 that is configured to receive a latch in a known manner (FIG. 100). The engagement of the dovetail projections 428 with channels 429 permit the hinge and strike trucks 425 and 426, respectively, to slide along the uprights 67A and 67B. However, the engagement of the dovetail projections 428 with the channels 429 prevents the removal of the hinge trucks 425 and 426 unless the trucks 425 and 426 are slid out of the lower ends 423A and 423B of uprights 67A and 67B, respectively. Specifically as shown in FIG. 101, the tapered side surfaces of channel 429 slidably engage the dovetail projections 428 to slidably retain the strike truck 426. The hinge truck 425 has substantially identical dovetail projections 428 as those shown in FIG. 101, and the hinge truck 425 is therefore slidably retained in substantially the same manner as strike truck 426.

Referring again to FIG. 99, after the hinge truck 425 is positioned in channel 429, it can be shifted along the track 429 as shown by the arrow “A.” The strike truck 426 (FIG. 100) can also be shifted along channel 429 in substantially the same manner. The number of hinge trucks 425 is typically the same as the number of hinges 64, whereas a single strike truck 426 is utilized. The hinge trucks 425 and strike truck 426 are preferably non-handed and symmetrical whereby the hinge trucks 425 and strike trucks 426 can be installed in any orientation, provided the hinge trucks 425 are positioned in the correct upright 67A and the strike truck 426 is positioned in the correct upright 67B.

With further reference to FIG. 102, a first or lower hinge truck 425A is positioned using a lower cover 430A having a length “L1.” The length L1 may be predetermined to properly position the first hinge truck 425A for a particular door configuration. Thus, cover 430A may be precut at the factory or other manufacturing facility so that the first hinge truck 425A can be properly positioned during assembly at an installation site.

An edge 432 of hinge cover 430A is positioned so it is flush with edge 431 of upright 67A, and edge 434 of hinge truck 425A may abut opposite edge 435 of hinge cover 430A to thereby properly position first hinge truck 425A. Pilot holes can then be drilled through upright 67A using openings 436 of hinge truck 425 (see also FIG. 99), and threaded fasteners 433 (e.g. self-tapping screws) can then be driven through the openings 436 into the openings that were drilled into upright 67A, thereby securing first hinge truck 425A to upright 67A. The cover 430A may be removed after installing a first screw 433A to permit a second screw 433B to be installed, and the hinge cover 430A may then be snapped in place. As shown in FIG. 101, edge 437 of cover 430A may be positioned in a channel 438 of upright 67A, and leg 439 of cover 430A may be snapped into channel 440 of upright 67A to thereby retain the hinge cover 430A on upright 67A.

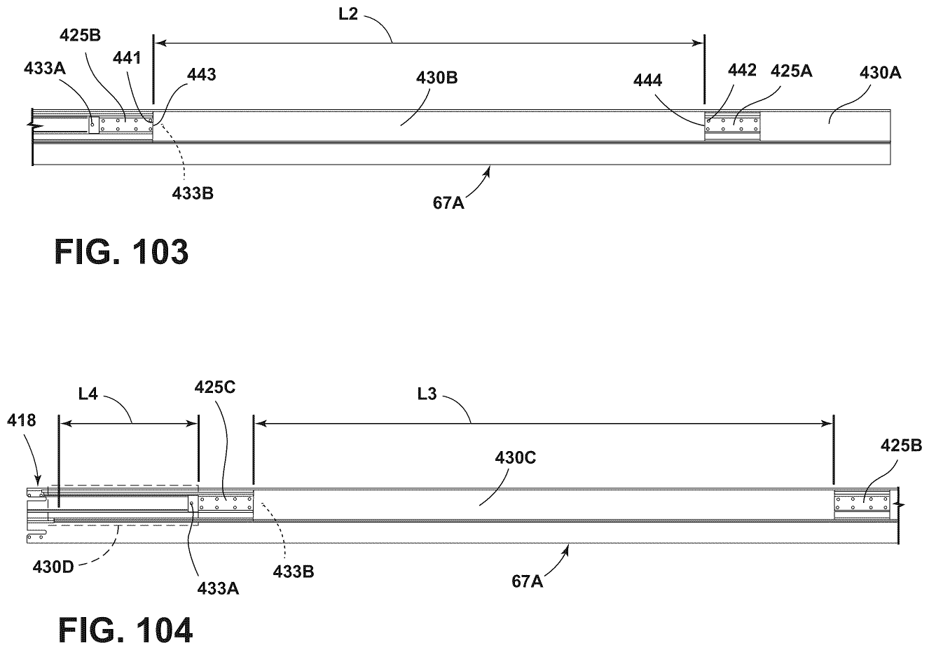

With further reference to FIG. 103, a hinge cover 430B is then used to position a second hinge truck 425B. The hinge cover 430B has a precut length “L2” that is precut to provide proper space in between hinge trucks 425A and 425B. Opposite edges 441 and 442 of cover 430B are positioned against edges 443 and 444, respectively, of hinge trucks 425B and 425A, respectively. Holes are then drilled, and threaded fasteners 433A and 433B are then utilized to secure the hinge truck 425 to the upright 67A. This process is repeated for each hinge truck 425. For example, with reference to FIG. 104, a hinge cover 430C may be utilized to position a hinge truck 425C, which is then secured in place utilizing threaded fasteners 433A and 433B. A distance “L4” may then be measured, and a top hinge cover 430D may then be cut to the length L4 and snapped in place adjacent upper end 418 of upright 67A.

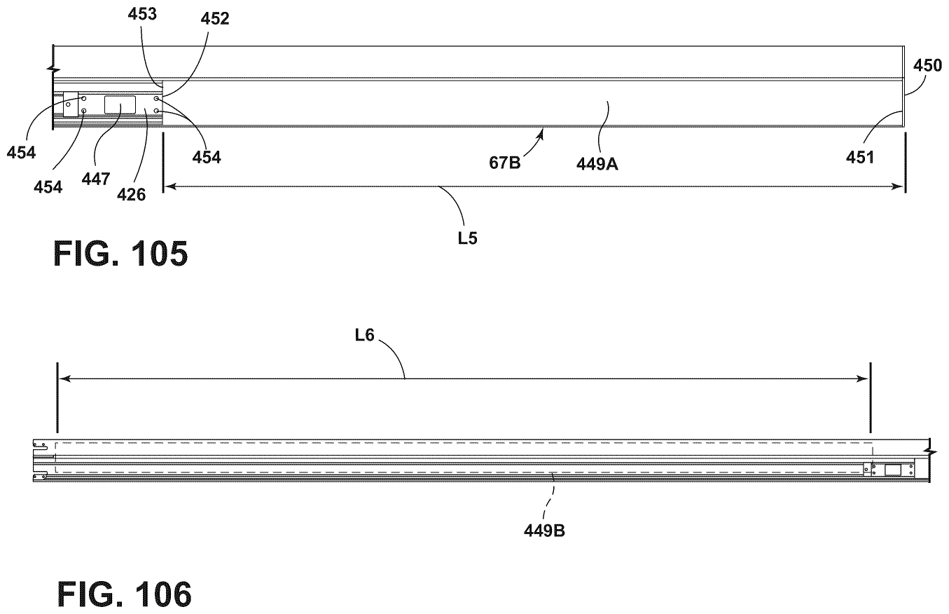

With further reference to FIG. 105, strike truck 426 may be positioned on upright 67B utilizing lower strike cover 449A. Specifically, lower edge 450 of lower strike cover 449A is positioned flush with lower edge 451 of upright 67B, and edge 452 of strike truck 426 is positioned in contact with upper edge 453 of lower strike cover 449A. The lower strike cover 449A has a predetermined (i.e. precut) length “L5” to properly position the strike truck 426 for the particular door assembly 60. Holes are then drilled into upright 67B utilizing openings 454 of strike truck 426 to locate the holes to be drilled, and threaded fasteners (e.g. self-tapping screws) are then inserted through openings 454 into upright 67B to secure strike truck 426 to upright 67B. The lower strike cover 449A may then be snapped into place.

With further reference to FIG. 106, a dimension “L6” may then be measured, and a top strike cover 449B may be cut to the length L6. The upper strike cover 449B may then be snapped into place.

With further reference to FIG. 107, post extension brackets 115 can be secured to uprights 67A and 67B utilizing threaded fasteners 455 that extend through an opening 456 in a plate 457, through a slot 458 in body 459, and into a threaded opening 460 in uprights 67A and 67B. An alignment or planarity clip 137 may be secured to one of the uprights 67A or 67B utilizing a threaded fastener 461 that extends through an opening 462 in clip 137 and into threaded opening 463 of upright 67A or 67B. Alternatively, instead of using threaded fastener 461, clip 137 may include a plurality of points 143 that engage lower surfaces of flanges 405 to thereby retain alignment clip 137 in position. In general, only a selected one of the uprights 67A and 67B will include an alignment clip 137. However, both uprights 67A and 67B could utilize an alignment clip 137 (e.g. if an adjacent panel does not have an alignment clip 137).

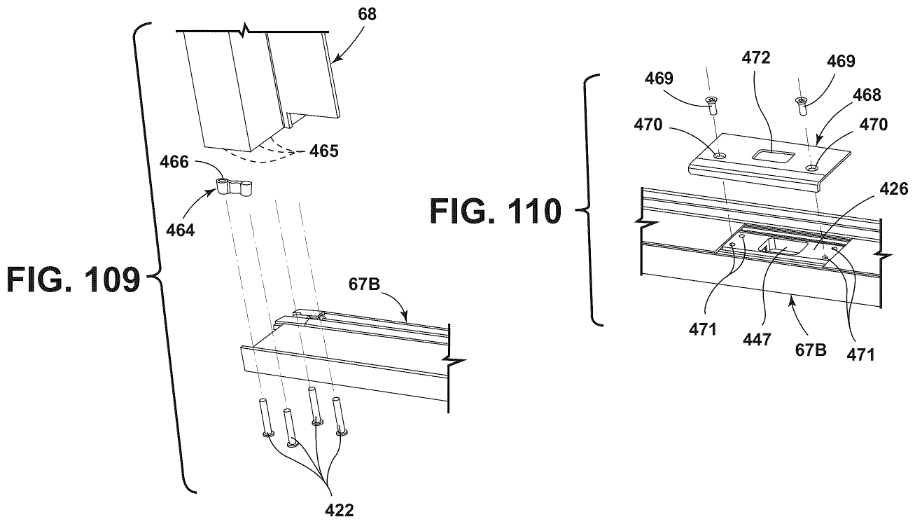

With further reference to FIGS. 108 and 109, the overhead 68 may then be assembled to the uprights 67A and 67B utilizing threaded fasteners 422. The overhead 68 may include screw bosses 465 that receive the threaded fasteners 422. A spacer block 464 includes openings 466 that receive threaded fasteners 422 to thereby provide proper positioning between opposite ends 68A and 68B and uprights 67A and 67B, respectively. It will be understood that the spacer block 464 is optional. With further reference to FIG. 110, strike plate 468 is then secured to strike truck 426 using threaded fasteners 469. In particular, threaded fasteners 469 extend through clearance openings 470 and strike plate 468 and into two of the threaded openings 471 in strike truck 426. Strike truck 426 may include a total of four threaded openings 471 whereby the strike plate 468 can be installed regardless of the orientation of strike truck 426. Strike plate 468 includes an opening 472 that aligns with opening 447 of strike truck 426. The openings 472 and 447 receive a door latch member to retain the door in a closed position in a known manner.

It is to be understood that variations and modifications can be made on the aforementioned structure without departing from the concepts of the present invention, and further it is to be understood that such concepts are intended to be covered by the following claims unless these claims by their language expressly state otherwise.

The invention claimed is:

1. A partition wall comprising:
a ceiling track;
a floor track;
a pair of upright partition frame members extending along vertical side edges of the partition panel assembly;
a lower partition frame member having opposite ends thereof secured to lower portions of the upright partition frame members;
an adjustable glide having a lower end that extends through the floor track to directly engage a floor surface and support the lower partition frame member above the floor track;
a clerestory assembly including a sheet of light-transmitting material and a clerestory frame, the clerestory frame including an upper clerestory frame member, a lower clerestory frame member, and a pair of upright clerestory frame members secured to the upright partition frame members;
wherein each clerestory frame member includes a pair of integral elongated tubular outer portions and a central channel between the elongated tubular outer portions, wherein outer edges of the sheet of light-transmitting material are disposed in each of the channels to retain the sheet of light-transmitting material;
and wherein the tubular outer portions of each clerestory frame member define exposed outer surfaces on first and second sides of the clerestory assembly that are opposite one another,
and wherein the exposed outer surfaces of each clerestory frame member on at least the first side of the clerestory assembly are coplanar;
and wherein opposite ends of the upper and lower clerestory frame members are rigidly interconnected to the upright clerestory frame members;
and wherein clerestory assembly further includes panel attachment structure below the lower clerestory frame member, and an opaque panel attached to the panel attachment structure of the lower clerestory frame member, the upright partition frame members, and the lower partition frame member, and wherein an outer surface of the opaque panel is substantially coplanar with the exposed outer surface of the tubular outer portion of the lower clerestory frame member.

2. The partition wall of claim 1, wherein:
at least one of the upper and lower clerestory frame members includes projections at opposite ends thereof extending through cut-outs in the upright clerestory frame members to block light and/or sound;
the upright clerestory frame members are secured to the upright partition frame by threaded fasteners;
the opposite ends of the upper and lower clerestory frame members include screw bosses at opposite ends thereof that receive fasteners extending through the upright clerestory frame members to rigidly interconnect the upper and lower clerestory frame members to the upright clerestory frame members.

3. The partition wall of claim 1, wherein:
each upright partition frame member includes an outer side face, each outer side face including a pair of flanges that are configured to abut a pair of flanges on an adjacent partition panel whereby a resilient attachment member can be positioned on the abutting flanges to connect the partition panel assembly to adjacent partition panels.

4. The partition wall of claim 3, wherein:
the outer side faces of the upright partition frame members define a panel width;
a length of the floor track is about equal to the panel width.

5. The partition wall of claim 1, wherein:
the panel attachment structure comprises a downwardly opening channel on a lower side of the lower clerestory frame member, the downwardly opening channel having spaced apart retaining surfaces;
the opaque panel including a latch having a movable retainer engaging a selected one of the retaining surfaces to retain an upper portion of the opaque panel to the lower clerestory frame member;
the lower clerestory frame member includes an upwardly opening channel having spaced apart retaining surfaces;
each of the upright clerestory frame members include inwardly facing channels;
the opaque cover includes at least one bracket adjacent a lower edge of the opaque cover, the bracket having a downwardly extending structure received in the upwardly opening channel of the lower clerestory frame member, the opaque cover further including latches adjacent opposite vertical side edges of the opaque cover, each latch including a movable retainer received in a selected one of the inwardly facing channels of the upright clerestory frame members to retain the opaque panel to the upright clerestory frame members.

6. The partition wall of claim 5, wherein:
each of the latches includes resilient members biasing the movable retainers into the channels, each movable retainer including a retaining surface and a tapered surface opposite the retaining surface whereby the tapered surfaces engage frame surfaces as the opaque panel is being installed, causing the movable retainers to shift against the bias of the resilient members until the opaque panel is in a fully installed position in which the movable retainers move into the channels due to the bias.

7. The partition wall of claim 1, including:
a glass partition assembly having first and second opposite sides, the glass partition assembly comprising:
one or more sheets of glass;
upper and lower glass partition frame members;
upright glass partition side frame members secured to the upper and lower frame members;
side trim members secured to the upright glass partition side frame members whereby vertical side edges of the one or more sheets of glass are positioned between the upright glass partition side frame members and the side trim members wherein the side trim members have outer profiles that are substantially identical to outer profiles of the upright glass partition side frame members whereby first and second opposite sides of the glass partition assembly have a substantially identical appearance;
upper spacers positioned at opposite ends of the upper glass partition frame member, wherein the upper spacers extend a profile of the upper glass partition frame member to the upright glass partition side frame members;
and wherein the upright glass partition side frame members, spacers, and upper and lower glass partition frame members are configured to be assembled to form a glass partition frame, whereby an upper edge of the one or more sheets of glass may be inserted into a groove of the upper glass partition frame member, followed by rotation of the one or more sheets of glass to an upright position, followed by shifting the one or more sheets of glass downward to insert a lower edge of the one or more sheets of glass into a groove of the lower glass partition frame member, followed by installing the side trim members to the upright glass partition side frame members.

8. The partition wall of claim 7, including:
lower spacers positioned at opposite ends of the lower glass partition frame member to extend a profile of the lower glass partition frame member to the upright glass partition side frame members; and wherein:
the upper spacers have an outer surface profile that is substantially identical to an outer surface profile of the upper glass partition frame member;
the lower spacers have an outer surface profile that is substantially identical to an outer surface profile of the lower glass partition frame member.

9. The partition wall of claim 8, wherein:
the one or more sheets of glass comprises three sheets of glass including a center sheet of glass having opposite vertical edges abutting vertical edges of first and second outer sheets of glass to form two vertical glass joints.

10. The partition wall of claim 9, including:
three floor track pieces that are operably interconnected to the lower glass partition frame member by glides, each glide having a lower end extending through an opening in an associated floor track piece, each glide further including a first member having external threads threadably engaging internal threads of a second member, the second member further including external threads threadably engaging internal threads of the bottom frame member, each glide further including a compression spring disposed between the associated floor track piece and the lower glass partition frame member and biasing the floor track piece away from the lower glass partition frame member.

11. The partition wall of claim 7, including:
an adjustment glide including a rod operably engaging the glass partition frame, a glide shaft having a lower end that is configured to engage a floor, the glide shaft threadably engaging the rod, the adjustment glide further including a gear that operably engages the glide shaft whereby rotation of the gear causes the glide shaft to rotate relative to the rod, the gear having teeth that are configured to be engaged by a drive bit of a portable power tool, whereby the gear can be rotated by a power tool to thereby rotate the glide shaft relative to the rod and to adjust a height of the glass partition frame relative to a floor due to vertical movement of the rod relative to the glide shaft.

12. The partition wall of claim 1, including:
a solid panel assembly including a rigid solid panel frame having upper and lower solid panel frame members and upright solid panel frame members interconnecting the upper and lower solid panel frame members, wherein each of the upper and lower solid panel frame members and each of the upright solid panel frame members have channels facing a central space of the rigid solid panel frame;
a panel attached to the rigid solid panel frame in an installed position by latches and brackets;
wherein the brackets include a portion that extends downwardly from a lower edge of the panel and engages the channel of the lower solid panel frame member whereby the panel is pivotable about the brackets during installation of the panel on the rigid solid panel frame;
wherein each latch includes a movable retainer that is biased towards a latched position;
wherein each of the movable retainers have an angled surface that is configured to engage the rigid solid panel frame and cause the movable retainer to move away from the latched position as the panel is pivoted about the brackets to the installed position on the rigid solid panel frame;
and wherein the movable retainers are configured to shift to the latched position when the panel is in the installed position due to the bias, the movable retainers having retaining surfaces that engage at least a selected one of the channels when the movable retainers are in the latched position to thereby retain the panel in the installed position on the rigid solid panel frame.

13. The partition wall of claim 12, wherein:
the panel includes vertical side edges and at least one side latch positioned adjacent each vertical side edge, wherein the movable retainers of the side latches are disposed in the channels of the upright solid panel frame members;
the panel includes a horizontal upper edge and at least one upper latch positioned adjacent the horizontal upper edge, wherein the movable retainer of the upper latch is disposed in the channel of the upper solid panel frame member.

14. The partition of claim 13, wherein:
the movable retainers shift linearly between retracted positions and latched positions;
the latches include housings that movable support the movable retainers;
each latch includes a spring biasing the movable retainer of the latch towards the latched position;
the angled surfaces and the retaining surfaces of the movable retainers are formed on ends of the movable retainers;
the upper latch and the side latches are positioned on an inner side of the panel;
the ends of the movable retainer of the upper latch and the side latches project outwardly beyond the vertical side edges and the horizontal upper edge, respectively, when the movable retainers are in the engaged position;
the angled surfaces and the retaining surfaces are on opposite sides of the ends of the movable retainers;
the brackets include angled surfaces that are configured to engage the upright solid panel frame members as the panel is rotated to the installed position if the panel is not initially centered on the rigid solid panel frame, whereby the panel is shifted horizontally to a centered position on the rigid solid panel frame as the panel is pivoted to the installed position.

15. A sliding door assembly for partition walls, the sliding door assembly comprising:
a stationary door frame including a pair of spaced apart upright frame members and a header connected to the upright frame members, the stationary door frame including first and second upwardly opening channels extending along an upper portion of the stationary door frame whereby the stationary door frame defines a door opening;
a ceiling track including downwardly extending side flanges that are received in the upwardly opening channels of the stationary door frame;
a door track structure including a roller-receiving channel and a downwardly opening hook, wherein an end of the hood is received in the first upwardly-opening channel of the stationary door frame to support the door track on the stationary door frame;
a door comprising a sheet of material and rollers at an upper edge of the sheet of material;
and wherein the rollers are disposed in the support channel to slidably support the door for horizontal movement.

16. The sliding door assembly of claim 15, wherein:
the upright frame members include a recess on a first side adjacent upper ends of the upright frame members;
the door track structure includes a downwardly extending structure that is disposed in the recesses.

17. The sliding door assembly of claim 16, wherein:
the door track structure comprises an upper structure, and the downwardly extending structure comprises a wall extending downwardly from the upper structure adjacent to the downwardly opening hook;
the header includes screw bosses at opposite ends thereof;
the upright frame members are secured to opposite ends of the header by threaded fasteners extending through openings in the upright frame members and into the screw bosses;
the upright frame members include flanges on outer sides, the flanges having a L-shape in cross section, with outer legs of the flanges extending in opposite directions whereby upright frame members of adjacent wall panels can be connected to the upright frame members by positioning resilient connectors on the flanges of the upright frame members and on flanges of adjacent wall panels that are abutting the flanges of the upright frame members;
threaded fasteners extending through openings in the wall and engaging threaded openings of the upright frame members to secure the door track structure to the upright frame members;
a glass wall panel connected to the stationary door frame; and wherein:
the door track structure extends along the upper portion of the stationary door frame and along an upper portion of the glass wall panel, whereby the door is movable along the door track structure from a closed position in which the door closes off the door opening, and an open position in which a portion of the door is disposed along side the glass wall panel;
the ceiling track extends over the stationary door frame and the glass wall panel, and upper portions of the stationary door frame and the glass wall panel engage the ceiling track.

18. A method of installing a door frame and a door in a partition wall, the method comprising:
measuring a vertical dimension of a door opening in a partition wall;
cutting side frame members to a length that will permit the side frame members to be positioned in the door opening in an upright position;
connecting the side frame members to an overhead frame member to form a door frame;
temporarily attaching floor brackets to lower ends of the side frame members;
temporarily positioning the door frame in an installed position in which the door frame engages a ceiling track of the partition wall and the floor brackets rest on a floor surface;
followed by marking the locations of the floor brackets on the floor surface;
followed by removing the door frame from the installed position;
followed by removing the floor brackets from the side frame members;
followed by positioning the floor brackets on the floor using the marked locations on the floor;
securing the floor brackets to the floor;
attaching the lower ends of the side frame members to the floor brackets; and
positioning the door frame in the door opening with the side frame members in upright positions.

19. The method of claim 18, wherein:
the wall system includes a glass wall panel adjacent to the door opening; and including:
causing a downwardly opening hook structure of the overhead door track to engage an upwardly opening channel of the door frame to connect the overhead door track to the door frame.

20. The method of claim 18, wherein:
a first one of the side frame members includes an elongated track;
the trim member comprises a first trim member;
the hinge track comprises a first hinge track;
the first and second hinge tracks include a base that engages the elongated track, and a projecting portion having side surfaces; and including:
causing at least one hinge track to slidably engage the elongated track;
securing the hinge track to the first side frame member at a predefined distance from a lower end of the first side frame member;
mounting a hinge to the hinge track;
attaching a swing door to the hinge;
utilizing a trim member having a predefined length to position the hinge track at the predefined distance;
attaching the trim member to the first side frame member below the hinge track after the hinge track is secured to the first side frame member;
after the lower hinge track is secured to the first side frame member, utilizing a second trim member to position a second hinge track on the first side frame member at a predefined distance from the first hinge track;
securing the second hinge track to the first side frame member;
attaching the second trim member to the first side frame member between the first and second hinge tracks;
securing a hinge to the second hinge track;
attaching a swing door to the hinge that is secured to the second hinge track;
causing opposite ends of the second trim member to engage the side surfaces of the first and second hinge tracks to thereby position the second hinge track relative to the first hinge track.
